(19) United States
(12) Patent Application Publication
(10) Pub. No.: US 2004/0219423 A1
(43) Pub. Date: Nov. 4, 2004

(54) Metal-supported solid electrolyte electrochemical cell and multi cell reactors incorporating same

(76) Inventors: Cathal Joseph Tunney, Edmonton (CA); Robert Donald Roy, Edmonton (CA); Fraser McClure, Edmonton (CA)

Correspondence Address: GREENLEE WINNER AND SULLIVAN P C, 5370 MANHATTAN CIRCLE, SUITE 201, BOULDER, CO, 80303, US

(21) Appl. No.: 10/475,938

(22) PCT Filed: Apr. 26, 2002
(86) PCT No.: PCT/CA02/00582

Related U.S. Application Data
(60) Provisional application No. 60/286,853, filed on Apr. 27, 2001.
(60) Provisional application No. 60/303,026, filed on Jul. 3, 2001.
(60) Provisional application No. 60/326,561, filed on Oct. 2, 2001.

(51) Int. Cl. H01M 8/10; H01M 4/86; H01M 8/02

(52) U.S. Cl. 429/127; 429/30; 429/44; 429/38

(57) ABSTRACT

The invention provides a metal-supported solid electrolyte electrochemical cell, multi cell reactor assemblies incorporating a plurality of such cells, and processes of forming the electrochemical cells. In one embodiment, the electrochemical cell includes a central electrolyte membrane, first and second perforated metallic layers adhered to each of the major surfaces of the central electrolyte membrane, and first and second outer, non-porous electrolyte layers formed above the metallic layers. In another embodiment, first and second inner, porous electrolyte layers are sandwiched on either side of the central membrane, between the first and second metallic layers. The electrochemical cell is thus generally formed from ceramic material as thin layers supported on non-porous, robust metallic layers, designed to behave as though made of metal. Preferably, the electrochemical cell includes metallurgically bonded electrical interconnects and/or gas seals.

### FIELD OF THE INVENTION

The present disclosure generally relates to electrochemical cells employing solid electrolytes where such solid electrolytes are ion conductors that conduct oxygen ions or protons or other ion species, or combinations of the foregoing. These solid electrolytes may exhibit exclusively ionic conductivity or a combination of ionic and electronic conductivity. Important applications of such electrochemical cells include solid oxide fuel cells, oxygen concentration cells, partial oxidation cells and reactor systems incorporating multiple cells.

### BACKGROUND OF THE INVENTION

Of the known applications of solid electrolyte electrochemical cells the most important are based on oxygen ion conducting ceramic electrolytes, which are also called solid oxide electrolytes. These applications are solid oxide fuel cells, oxygen concentration cells, which are also known as oxygen pumps, and partial oxidation cells. Examples of solid oxide fuel cells are described in U.S. Pat. No. 4,490,445, U.S. Pat. No. 5,741,406 and U.S. Pat. No. 6,106,967. U.S. Pat. No. 4,877,506 describes an oxygen pump. U.S. Pat. No. 5,681,373 describes a solid oxide cell suitable as an oxygen concentration or partial oxidation reactor. U.S. Pat. No. 5,770,326 describes a monolithic mass and energy transfer cell using solid oxide electrolytes suitable for all three of the aforementioned applications.

The discussion herein, of the merits of various solid electrolyte electrochemical cell designs, will focus on solid oxide fuel cells. However, one skilled in the art will readily recognize that the same or similar challenges arise in designing all types of solid electrolyte electrochemical cells. Fuel cells of all types, including Proton Exchange Membrane (PEM), Molten Carbonate (MCFC), Phosphoric Acid (PAFC), Alkaline (AFC) and Solid Oxide (SOFC), have recently been the focus of much development effort because they promise a more environmentally sustainable alternative to meeting the world's growing demand for electrical and mechanical energy than do energy conversion systems based on conventional combustion processes. Relative to competing fuel cell technologies, solid oxide fuel cells offer several advantages primarily related to their high operating temperature. The principal advantages of solid oxide fuel cells are high energy conversion efficiency, high quality byproduct heat, simpler fuel processing systems when using reformed hydrocarbon fuels, and avoidance of the expensive precious metal catalysts required in low temperature fuel cells.

The fundamental operation of all oxygen ion conducting solid oxide electrochemical cells is similar. Oxygen gas on the cathode side of a gas impermeable solid oxide electrolyte membrane is chemically reduced to oxygen ions, each carrying two extra electrons. These oxygen ions then migrate through the ionically conductive electrolyte membrane to the anode side of the cell where they may recombine to again form oxygen gas or may react with other gaseous species, such as by reacting with hydrogen to form water. For solid oxide electrolyte materials there is a strong direct relationship between ionic conductivity and temperature. Therefore, to achieve useful current densities the cell is typically operated at temperatures in the range of 600° C. to 1100° C. In order that the oxidation reactions at the anode can proceed the surplus electrons carried by the oxygen ions must migrate back to the cathode side of the solid oxide membrane. The path by which the electrons on the anode side of the membrane migrate back to the cathode side may be either internal to the electrolyte membrane, external to the electrolyte membrane, or both. Where the electrolyte membrane exhibits both ionic and adequate electronic conductivity no external circuit is required to electrically connect the anode and cathode electrodes. Otherwise, such an external electrical circuit is required. In the case of a solid oxide fuel cell, the driving force for the electrochemical reactions is provided by the difference in the partial pressure of oxygen between the cathode and anode side of the cell which creates a voltage differential between the cathode and anode electrodes. Conversely, in the case of an oxygen pump an externally applied electrical bias is used to increase the partial pressure of oxygen on the anode side of the cell over that on the cathode side. If used as a partial oxidation cell, the driving force delivering oxygen to the anode side of the cell may be either an oxygen partial pressure difference, an external electrical bias or both.

All solid electrolyte electrochemical cells, including solid oxide fuel cells, are comprised of the same basic functional elements. The central element is a solid electrolyte membrane that is gas impermeable. Depending on the application, the electrolyte is designed to be exclusively an ionic conductor or a mixed ionic and electronic conductor. For solid oxide fuel cells, where the goal is to maximize the external voltage generated, the requirement is that the electrolyte membrane be, to the greatest extent possible, exclusively an ionic conductor. On either side of the electrolyte membrane and in intimate contact with it are electrode layers that have several functions. The electrodes must provide: a high density of reaction sites for the electrochemical reactions, ionically conductive pathways to conduct ion species between the reaction sites and the electrolyte membrane, electrically conductive pathways to conduct electrons to and from reaction sites to external current collectors, and unrestricted flow of gasses to and from reaction sites. To complete the cell the electrodes must be interconnected electrically and a gas containment and transport means provided adjacent to each electrode to direct the different reacting gas streams to and from the appropriate electrode surfaces. To produce commercially useful systems multiple single cells are interconnected, typically in electrical series, and assembled into bundles for tubular cell designs or stacks for planar cell designs.

Minh, Ceramic Fuel Cells, Journal of the American Ceramics Society, 76[3] 563-88 (1993) provides a useful review of the engineering challenges involved in designing solid oxide fuel cells and multi cell systems, and of the approaches that have been proposed to meet these challenges. Fundamentally, the difficulties in making commercially viable solid oxide fuel cells relate to the high temperatures required to achieve useful current density and to the fact that at least the electrolyte membrane is made of mechanically unforgiving ceramic materials. In most designs not only the electrolyte membrane but one or more of the cathode, the anode and the electrical interconnect element, used to electrically connect a number of individual cells together, are also made of mechanically unforgiving ceramic or cermet (ceramic-metal composite) materials. In addition to the limited ability of these ceramic materials to withstand direct tensile loads they also have very limited ability to withstand thermally induced stresses. This means that great care must be taken to minimize thermal gradients within the cell as well as thermal expansion mismatches between the different materials used to build the cell and the electrical interconnects and gas manifolds that must be connected to it. Finally, it is difficult to make reliable electrical connections to the porous ceramic cell electrodes and to provide reliable gas tight seals to keep fuel and oxidant gas streams from mixing.

In early solid oxide fuel cell designs the structural support for the cell was provided by a relatively thick dense ceramic electrolyte membrane, typically in the form of a flat plate or cylindrical tube, to which relatively thin anode and cathode electrodes were bonded. This provided a relatively simple structure but a long ionic conductor path length requiring operating temperatures of 1000° C. or higher. More recently cell structures that permit the thickness of the electrolyte membrane to be reduced to the range of 10 μm or less have been demonstrated to provide useful current densities at operating temperatures in the range of 600° C. to 800° C. To accommodate a thin electrolyte membrane requires that either the anode or cathode must now provide the structural support for the cell and so must be made relatively thick. However, the thick supporting electrode must also provide unrestricted access for the reacting gases to reach close to the electrolyte membrane in order to maintain the desired short ionic conductor path length. The consequence is that the supporting electrode must be made both thick and highly porous. This in turn complicates the realization of a gas impermeable electrolyte membrane since it is difficult to build a thin gas impermeable ceramic layer by deposition on or lamination to a porous substrate.

While anode or cathode supported solid oxide fuel cells with thin electrolyte membranes and operating at temperatures below 800° C. have less stringent materials selection requirements than their thick electrolyte membrane predecessors, these cell designs continue to exhibit a number of deficiencies that significantly limit their commercial potential. The fact that at least the electrode providing structural support to the cell must be relatively thick means that gas transport, to and from the interface between the electrolyte membrane and the electrode, through this porous electrode is restricted. In the extreme, this mass transport limitation can become the rate-limiting factor for the cell's electrochemical reactions resulting in increased electrode overpotential losses. Increased electrode overpotential causes reduced voltage output and reduced efficiency for the cell.

No means has yet been found to provide solid oxide fuel cells with reliable gas seals. The prior art teaches two basic approaches: a mechanical compression seal using a pliant high temperature sealing gasket, and glass seals such as are used to make the glass to metal seal in light bulbs. Neither approach produces a seal that can withstand rapid thermal cycling or significant pressure differentials.

Neither does the prior art teach how to make durable low resistance electrical connections to the cell electrodes. The conventional approach is a surface to surface compression contact where the contact interface is subject to significant change and degradation in electrical performance, occurring over time at the cell's operating temperature. Since each individual cell requires two such connections the resistive voltage losses for a stack of cells connected in electrical series increase as the number of cells in the stack increases. Therefore, the voltage output of a fuel cell stack is significantly less than the sum of the voltage output from its individual constituent cells.

U.S. Pat. No. 3,464,861 and U.S. Pat. No. 5,328,779 teach solid oxide fuel cells supported on porous metal and/or intermetallic electrodes wherein these electrodes may be sufficiently robust electrical conductors to enable electrical interconnect at the electrode's outer perimeter rather than by surface to surface contact across its active surface. However, these cells are manufactured by thermal spray processes that are limited to producing relative thick central electrolyte membranes that require cell operating temperatures above 800° C. to achieve useful current densities. These high operating temperatures make the use of porous metal support electrodes infeasible because of continued sintering of the porous metal resulting in loss of electrode activity, volatilization of chromium oxide from electrically conductive oxide scale on the surface of the metal which then poisons electrochemically active sites, growth of electrically resistive oxide scale on the surface of the metal resulting in high internal cell resistance, or a combination of two or more of these effects.

Even with reduced operating temperatures, prior art solid oxide fuel cells must be started up slowly, especially if starting from ambient temperature. This results because the cell's structural characteristics are dominated by the thermal shock behaviour of the ceramic materials incorporated therein. This slow startup performance is a major impediment to the adoption of solid oxide fuel cells for transportation applications. Another important consequence of having to limit thermal gradients within a solid oxide fuel cell is the requirement to limit the difference in temperature between incoming and outgoing air to about 100° C. Air is typically used both as the source of oxygen for the cathode electrode and as the means to remove the surplus heat produced by the electrochemical reactions. By limiting the allowable temperature gain for the air passing through the cell to about 100° C., 3 to 5 times more air than is required to deliver the required amount of oxygen must be used. Consequently, the air handling system is larger than would otherwise be required resulting in increased system capital costs and reduced system efficiency.

Thermal management is in fact a very significant issue in practical solid electrolyte electrochemical cell reactors since the electrochemical reactions typically generate a lot of surplus heat. As already stated, the conventional approach to thermal management in solid oxide fuel cells is to blow surplus air through the stack, which air can contact and remove heat from the cathode surfaces. By a series of heat exchangers, the heated exhaust air is then used to preheat incoming fuel gas and/or incoming air. Even if the fuel cell stack could tolerate a larger differential in temperature between the incoming and outgoing air, a large volume of cooling air must be circulated since air is not a good heat transfer fluid. Also, as the volume specific current density of a solid oxide fuel cell stack increases, as is desirable to minimize size and cost, the volume specific mass of circulating heat transfer fluid must also increase. Therefore it is desirable that solid oxide fuel cell stacks be compatible with the use of liquid heat transfer fluids as this could make possible significant reductions in the size of the thermal management system. However, using liquid heat transfer fluids in conventional solid oxide fuel cell stacks would generate intolerable thermal gradients resulting in mechanical failure of the individual cells and/or the gas seals.

Considering thermal management in the context of minimizing thermally induced stresses in individual cells, which is desirable for long cell life even where the cell can tolerate significant thermal gradients, prior art solid electrolyte electrochemical cells do not provide a means to compensate for differences in the concentration and/or temperature of the reacting gases at different areas over the cell surface. Such differences in the concentration and/or temperature of the reacting gases as they are delivered to the cell may cause areas of increased or decreased electrochemical activity relative to the average electrochemical activity over the complete area of the cell. These differences in electrochemical activity can, in turn, magnify preexisting temperature differences or translate gas concentration differences into temperature differences, thus contributing to or causing thermal gradients.

In prior art solid oxide fuel cells using cermet anode materials, such as the commonly used nickel and yttria stabilized zirconia composite, cell performance is seriously reduced by even trace amounts of sulphur impurities in the fuel gas. The exposed metal surfaces are quickly attacked by sulphur destroying their catalytic activity. Neither are conventional cermet anodes tolerant to fuel gas interruptions and consequent exposure to oxidizing atmospheres at the cell operating temperature. In this case the nickel metal is quickly oxidized resulting in a severe loss in electrical conductivity for the anode electrode. Likewise, conventional cermet anodes cannot be switched sequentially from anode to cathode operation as would be useful to burn off accumulated carbon deposits that may result when the cell is run on hydrocarbon fuel.

Although it is possible and desirable to reform hydrocarbon fuel directly on the anode electrode of a solid oxide fuel cell, and this is desirable since it provides the closest possible thermal integration between the exothermic electrochemical reactions and the endothermic reforming reactions, it is difficult to achieve in practice. This is particularly true with heavier hydrocarbon fuels such as gasoline because of the carbon build-up issue described already and also because of inadequate catalytic activity to facilitate the reforming, reactions. It would therefore be advantageous to incorporate specialized reforming catalysts, which may be fuel specific, into or onto the surface of the anode electrode. However, this is difficult to accomplish on porous anode electrodes where open interconnected porosity must also be maintained.

### SUMMARY OF THE INVENTION

Accordingly, the inventors have recognized a need for improved solid electrolyte electrochemical cells and multi cell reactors providing:

Thin, preferably less than 10 μm thick, yet robust electrolyte membranes that enable reduced cell ionic resistance and useful current density at operating temperatures at or below 800° C. and preferably at temperatures below 650° C.;

An open, non-porous electrode structure that minimizes the mass transport limitations associated with porous electrodes, thus reducing cell overpotential losses,

and facilitating the incorporation of specialized catalysts into or onto the electrode surface;

Reliable gas seals and electrical interconnects;

The ability to withstand significant thermal gradients, thus permitting fast start-up and shut-down;

Electrodes that can operate interchangeably as a cathode or anode, thus providing tolerance for operating upsets and permitting the burn-off of contaminants such as carbon, which can accumulate on and disrupt the operation of anode electrodes when such anode electrodes are operated in the presence of hydrocarbon gas;

The ability to deliberately provide differences in electrochemical activity between different areas across the cell's surface so as to compensate for differences in the concentration and/or temperature of reacting gasses at such different areas and thereby limit thermal gradients over the whole area of the cell; and

The ability to use liquid heat transfer fluids to facilitate thermal management of multi cell reactors.

Broadly, the present invention provides a flexible, metal-supported, solid electrolyte electrochemical cell comprising:

a) a central, non-porous, ionically- or mixed ionically- and electronically-conducting electrolyte membrane which is less than 10 μm thick and defines two major surfaces, one major surface on each side of the central electrolyte membrane;

b) a first, non-porous, metallic layer which is adhered to one of the major surfaces of the central electrolyte membrane, and having a plurality of perforations extending therethrough forming a first pattern of perforations;

c) a second, non-porous, metallic layer which is adhered to the other of the major surfaces of the central electrolyte membrane, and having a plurality of perforations extending therethrough forming a second pattern of perforations;

d) a first outer, non-porous, ionically- or mixed ionically- and electronically-conducting electrolyte layer which is:

adhered to the first metallic layer and makes intimate contact with the central electrolyte membrane through the first pattern of perforations, and

continuously ionically-conductive throughout its bulk, and electronically-conductive through its thickness from the underlying first metallic layer to any reacting gases at its outer surface;

e) a first, ionically-conductive, interface formed at a contact surface between the first outer electrolyte layer and the central electrolyte membrane;

f) a first, electronically-conductive, interface formed at a contact surface between the first metallic layer and the first outer electrolyte layer;

g) a second outer, non-porous, ionically- or mixed ionically- and electronically-conducting electrolyte layer which is:

adhered to the outer surface of the second metallic layer and makes intimate contact with the central electrolyte membrane through the second pattern of perforations, and

continuously ionically-conductive throughout its bulk, and electronically-conductive through its thickness from the underlying second metallic layer to any reacting gases at its outer surface;

h) a second, ionically-conductive interface formed at a contact surface between the second outer electrolyte layer and the central electrolyte membrane; and

i) a second, electronically-conductive interface formed at a contact surface between the second metallic layer and the second outer electrolyte layer.

The invention also extends to flexible metal-supported solid electrolyte electrochemical cell substantially as above, but having, instead of the first and second porous, outer electrolyte layers, first and second porous, inner electrolyte layers formed between the metallic layers and the central electrolyte membrane.

The invention also broadly provides reactor assemblies with a plurality of the flexible metal-supported solid electrolyte electrochemical cells connected together in electrical series, and to processes to produce the flexible metal-supported solid electrolyte electrochemical cells.

### BRIEF DESCRIPTION OF THE DRAWINGS

FIG. 1a shows a plan view of a segment of a typical metal-supported solid electrolyte electrochemical cell of the present invention;

FIG. 1b shows a cross sectional view along line A-A of FIG. 1a;

FIG. 2a shows an expanded cross sectional view of a typical metal-supported solid electrolyte electrochemical cell illustrating details of the ionically- and electronically-conductive interfaces and representative reactions for such a cell operated as a solid oxide fuel cell;

FIG. 3a shows a plan view of a multi cell reactor incorporating multiple metal-supported solid electrolyte electrochemical cells and metallic interconnect elements;

FIG. 3b shows a cross sectional view along line A-A of FIG. 3a;

FIG. 4a is a cross sectional view along line b-b of FIG. 3a, showing a multi cell reactor incorporating multiple metal-supported solid electrolyte electrochemical cells that illustrates schematically how the gas flow channels adjacent to the cell surfaces are connected to gas supply and exhaust manifolds;

FIG. 4b is an expanded cross sectional view of the detail in circle C of FIG. 3b showing a metallurgically bonded interconnection and gas seal;

FIG. 5a shows a plan view of representative patterns of perforations in the metallic layers in which the patterns of perforations overlap so that areas of the central electrolyte membrane are exposed and not supported by either metallic layer;

FIG. 5b is an expanded cross sectional view of the detail in circle A in FIG. 5a;

FIG. 6a shows a schematic layout of a metal-supported solid electrolyte electrochemical cell reactor assembly, wherein the legend for the gas supply and exhaust manifolds is taken along line X-X of FIG. 6a;

FIG. 6b is a cross sectional view taken along line A-A of FIG. 6a;

FIG. 6c is a cross sectional view taken along line B-B of FIG. 6a;

FIG. 7a shows a schematic layout of a dimpled metallic interconnect element, with ∩ denoting top side (raised) dimples and ∪ representing bottom side (depressed) dimples;

FIG. 7b is a cross sectional view along line A-A of FIG. 7a;

FIG. 8 shows a flow chart summarizing a representative manufacturing process for building a reactor assembly incorporating metal-supported solid electrolyte electrochemical cells;

FIG. 9 is an expanded cross sectional view of a second embodiment of the invention, showing a typical metal-supported solid electrolyte electrochemical cell with porous inner electrolyte layers operating as a solid oxide fuel cell and illustrating the gas flow pathways for such a cell; and

FIG. 10 shows a flow chart summarizing a representative manufacturing process for building a reactor assembly incorporating metal-supported solid electrolyte electrochemical cells having the porous inner electrolyte layers of the second embodiment.

### DESCRIPTION OF THE PREFERRED EMBODIMENT

### Metal-Supported Solid Electrolyte Electrochemical Cell And Multi Cell Reactor Assembly Incorporating Same

a) Overview

The invention extends to metal-supported solid electrolyte electrochemical cell and multi cell reactors (or reactor assemblies) incorporating such cells. In a preferred embodiment a metal-supported solid electrolyte electrochemical cell incorporating metallurgically bonded electrical interconnects and/or gas seals is provided. From a structural perspective, this metal-supported solid electrolyte cell, by incorporating all the ceramic materials as thin layers supported on non-porous, robust metallic layers, is designed to behave as though it were made of metal. Thus, the mechanical difficulties arising with brittle ceramic structures can be eliminated or significantly reduced. In particular, the solid electrolyte electrochemical cells described herein are capable of tolerating significant thermal gradients. In addition, since the electronic conductors in both electrodes are predominantly metallic, electronic resistive losses within the cell are minimized and the electronic resistive loss penalty associated with reduced operating temperature is significantly reduced. These losses are significant for electrodes made only of electronically conductive ceramics. In this context it should be understood that the metallic layers may be comprised of individual metals and/or alloys and/or layered composites comprising one or more different metals and/or one or more different alloys. The metallic layers may also comprise, dispersed throughout their bulk and/or at their surfaces, a minor amount of one or more discontinuous ceramic phases provided that the predominantly metallic nature, in terms of mechanical and electrical conductivity properties, of the metallic layers is preserved.

As used herein to describe the metallic and/or ceramic layers of the metal-supported solid electrolyte electrochemical cell, the terms “non porous”, “non-porous” and “dense” do not mean that these layers have no porosity but rather that these layers do not exhibit interconnected through porosity, and consequently are gas impermeable. A fundamental prerequisite for such a metal-supported solid electrolyte cell is that the metals or alloys used provide sufficient mechanical strength and stability, e.g. oxidation resistance, at the cell operating temperature or that the operating temperature of the cell be reduced such that this requirement is satisfied. The cell operating temperature can be reduced by—using electrolyte materials exhibiting higher ionic conductivity, and/or shortening the average length of the ionic conductor path between the electrochemically active sites on the anode side of the cell and the electrochemically active sites on the cathode side of the cell.

### b) Description of First Embodiment

In a first embodiment, the metal-supported solid electrolyte electrochemical cell includes a central electrolyte membrane defining two major surfaces, one major surface on each side of the electrolyte membrane. Adhered to one major surface of the central electrolyte membrane is a first metallic layer which is formed with a first pattern of perforations. Adhered to the other major surface of the central electrolyte membrane is a second metallic layer, the second metallic layer forming a second pattern of perforations. Adhered to the outer surface, that is the surface not adhered to the central electrolyte membrane, of the first metallic layer is a first outer electrolyte layer that makes intimate contact with the central electrolyte membrane where such membrane is exposed by the first pattern of perforations. The interface between the first outer electrolyte layer and the central electrolyte membrane defines a first ionically conductive interface. The interface between the first metallic layer and the first outer electrolyte layer defines a first electrically conductive interface. Adhered to the outer surface, that is the surface not adhered to the central electrolyte membrane, of the second metallic layer is a second outer electrolyte layer that makes intimate contact with the central electrolyte membrane where such membrane is exposed by the second pattern of perforations. The interface between the second outer electrolyte layer and the central electrolyte membrane defines a second ionically conductive interface. The interface between the second metallic layer and the second outer electrolyte layer defines a second electrically conductive interface.

The cell is completed by providing metallic interconnect elements, including gas seals and electrical interconnects, to conduct reacting gases to and from each side of the metal-supported solid electrolyte membrane and to electrically connect the first metallic layer to the second metallic layer through an external electrical circuit.

The central electrolyte membrane, the first outer electrolyte layer and the second outer electrolyte layer may be exclusively ionic conductors or may be mixed ionic and electronic conductors. The central electrolyte membrane, the first outer electrolyte layer and the second outer electrolyte layer may each be comprised of a single electrolyte material, a mixture of different electrolyte materials, a layered composite of different electrolyte materials, or a combination of all of the foregoing. Each of the first outer electrolyte layer and the second outer electrolyte layer includes a continuous ionically conductive phase throughout and in addition provides an electronically conductive path, through its thickness, from the adjacent underlying electrically conductive interface to the reacting gases at its outer surface. Where the first outer electrolyte layer and/or the second outer electrolyte layers is formed predominantly of ionically conductive phases, the layer is made sufficiently thin to permit electrons to migrate through its thickness. Preferably, the first and second outer electrolyte layers include one or more electrolyte phases that exhibit both ionic and electronic conductivity, or comprise a multi phase mixture of one or more predominantly ionically conducting and one or more predominantly electronically conducting phases, or comprise a combination of the foregoing.

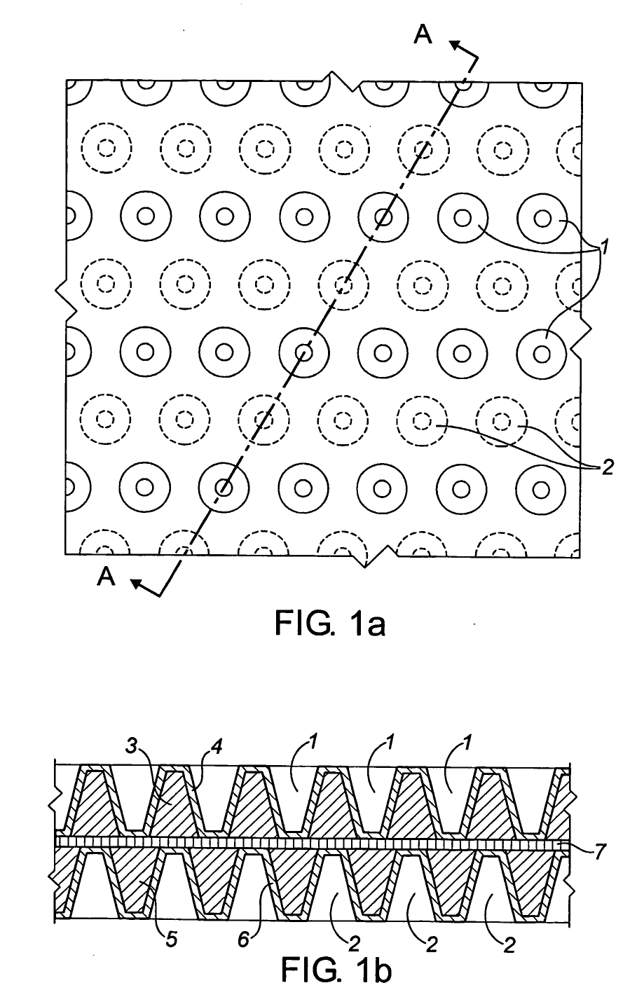

This first embodiment is illustrated generally in FIG. 1-FIG. 8, and is described below in greater detail.

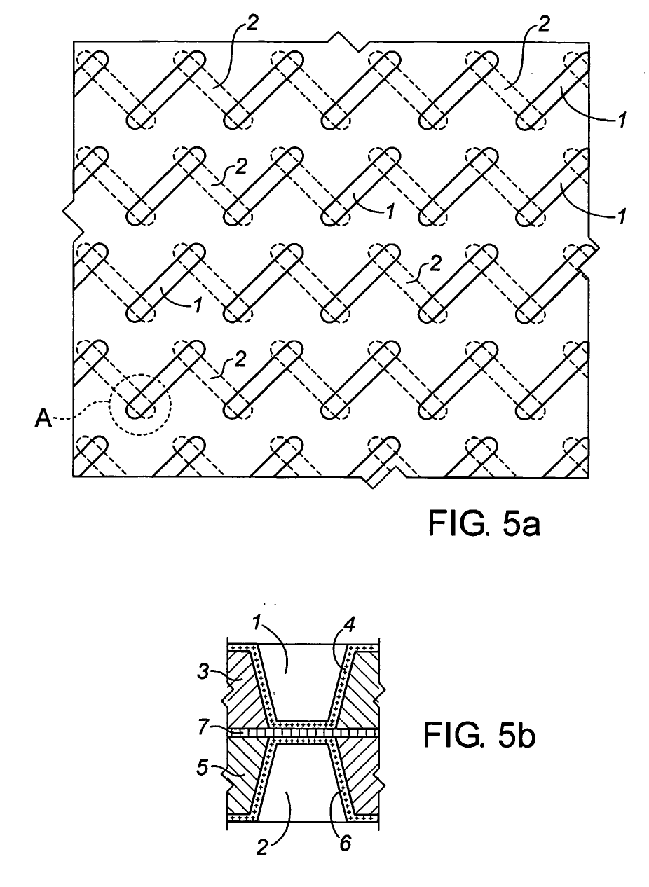

FIGS. 1a and 1b show a schematic plan view of a segment of a typical metal-supported solid electrolyte electrochemical cell as well as a schematic cross sectional view through such a cell. The first pattern of perforations 1 are shown penetrating through the first metallic layer 3 and the second pattern of perforations 2 are shown penetrating through the second metallic layer 5. As illustrated in FIGS. 1a, 1b, the perforations may be conical in shape and the first pattern of perforations 1 may be offset from the second pattern of perforations 2 (i.e., they are not aligned) such that the central electrolyte membrane 7 is everywhere supported by either the first metallic layer 3 or the second metallic layer 5. In FIGS. 5a, 5b, the first and second perforations 1, 2 are shown in an overlapping, partially aligned arrangement, so that areas of the central electrolyte membrane 7 are exposed in the aligned areas. However, the perforations may be of any shape and arranged in many different patterns as long as adequate structural support is everywhere provided to the central electrolyte membrane. The first outer electrolyte layer 4 is shown to completely cover that surface of the first metallic layer 3 which is not in contact with the central electrolyte membrane 7 and to cover the central electrolyte membrane 7 where it is exposed by the first pattern of perforations 1. Likewise, the second outer electrolyte layer 6 is shown to completely cover that surface of the second metallic layer 5 not in contact with the central electrolyte membrane 7 and to cover the central electrolyte membrane 7 where it is exposed by the second pattern of perforations 2. While it may be desirable, it is not essential that the outer electrolyte layers cover the central electrolyte membrane where the membrane is exposed by the first and second pattern of perforations.

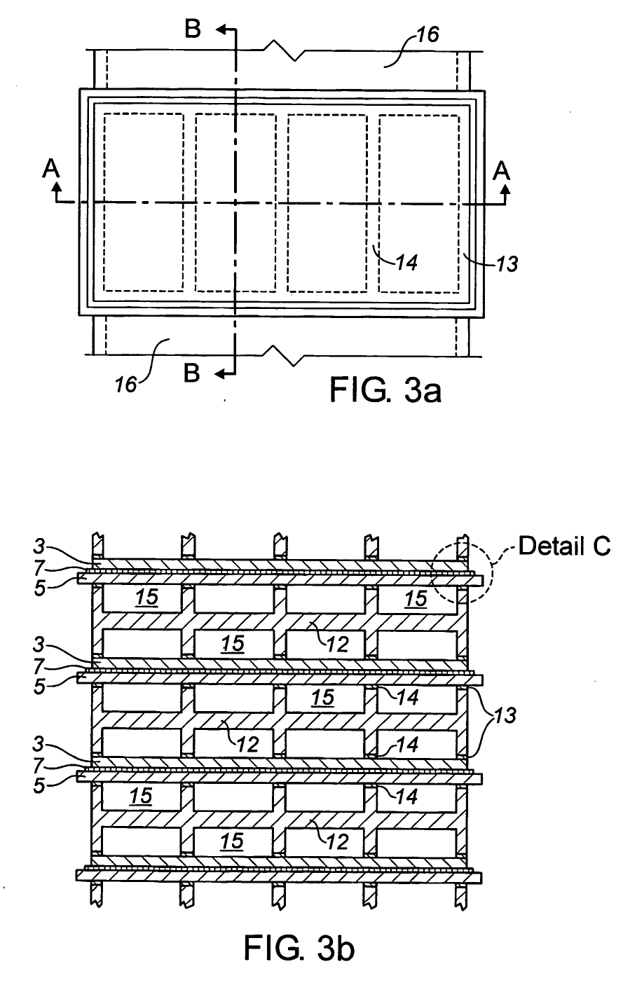

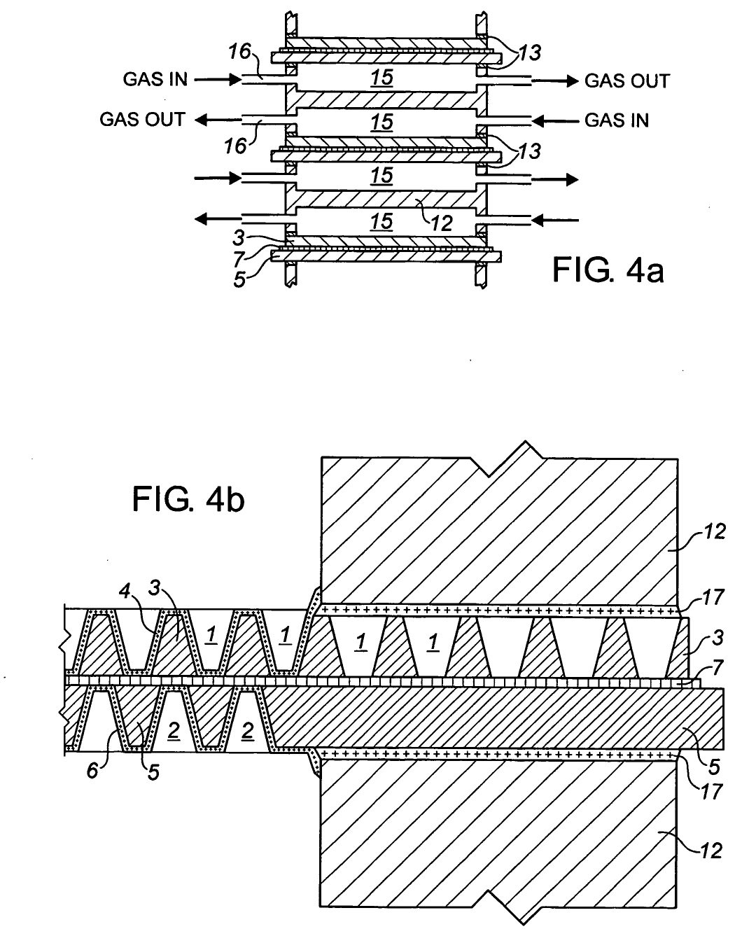

FIGS. 3a and 3b show a schematic plan view and a schematic sectional view of a multi cell reactor incorporating metal-supported solid electrolyte electrochemical cells and metallic interconnect elements. The interconnect elements 12, 13 and 14, provide both series electrical interconnection between the stacked cells and gas flow channels to transport the relevant gases to and from the electrode surfaces. FIGS. 4a and 4b show different sectional views of this same reactor. It should be noted that, to ensure clarity, the first and second pattern of perforations and the first and second outer electrolyte layers are not shown in these drawings although it is to be understood that they are present. The peripheral gas seals, the electrical interconnects 13, and/or the interior interconnects 14 may be made by several techniques, alone or in combination with each other. Firstly they may be made by direct compression contact between the first metallic layer 3 and/or the second metallic layer 5 and the metallic interconnect element 12. Alternatively they may be made by compression contact to a pliant metallic gasket inserted between the first metallic layer 3 and/or the second metallic layer 5 and the metallic interconnect element 12. Alternatively they may be made by metallurgically bonding the first metallic layer 3 and/or the second metallic layer 5 to the metallic interconnect element 12. The preferred approach, which is described in more detail below, is to make at least the peripheral gas seal and electrical interconnects 13 by metallurgically bonding both the first metallic layer 3 and the second metallic layer 5 to the metallic interconnect elements 12.

FIGS. 3a, 3b, 4a and 4b also illustrate an important detail for maintaining electrical isolation between the first metallic layer 3 and the second metallic layer 5 at the perimeter and/or at the edge of openings through the metal-supported cell. Where such electrical isolation is desired, the central electrolyte membrane 7 is selected to provide little or no electronic conductivity, and can therefore be considered as an electrical insulator. Electrical isolation at the perimeter of the cell and/or at the edge of openings through the cell is provided by deliberately extending the central electrolyte membrane 7 beyond the termination of at least one of the first metallic layer 3 or the second metallic layer 5. As shown in FIGS. 3a, 3b, 4a and 4b, the central electrolyte membrane 7 extends beyond the termination of the first metallic layer 3.

As represented in FIGS. 3a, 3b, 4a and 4b, the metal-supported solid electrolyte electrochemical cells and their associated metallic interconnect elements are shown to be both planar and rectangular in shape. By “planar” is meant that each cell occupies a single plane and all the cells and the metallic interconnect elements in the reactor are arranged in a series of parallel planes. However, since both the individual cells and the metallic interconnect elements are thin and flexible, they in fact exist as complex curved surfaces. The plan projection of the outer perimeter of an individual metal-supported cell and its associated metallic interconnect elements may be of any shape including, for example, circular, square, rectangular and hexagonal. Within this outer perimeter the cell may or may not have openings or holes to accommodate gas supply and exhaust manifolds that intersect the surface of the cell. The primary considerations in selecting the shape for metal-supported cells are minimization of electronic conductor path length from anode to cathode, ease of integration with gas supply and exhaust manifolds, ease and maximization of material utilization in manufacturing, and ready scale-up of the cell to larger size. A rectangular shaped cell with gas supply and exhaust manifolds arranged at the perimeter along both long sides provides for all of the foregoing objectives and is, therefore, a preferred shape and gas manifolding arrangement for metal-supported solid electrolyte electrochemical cells.

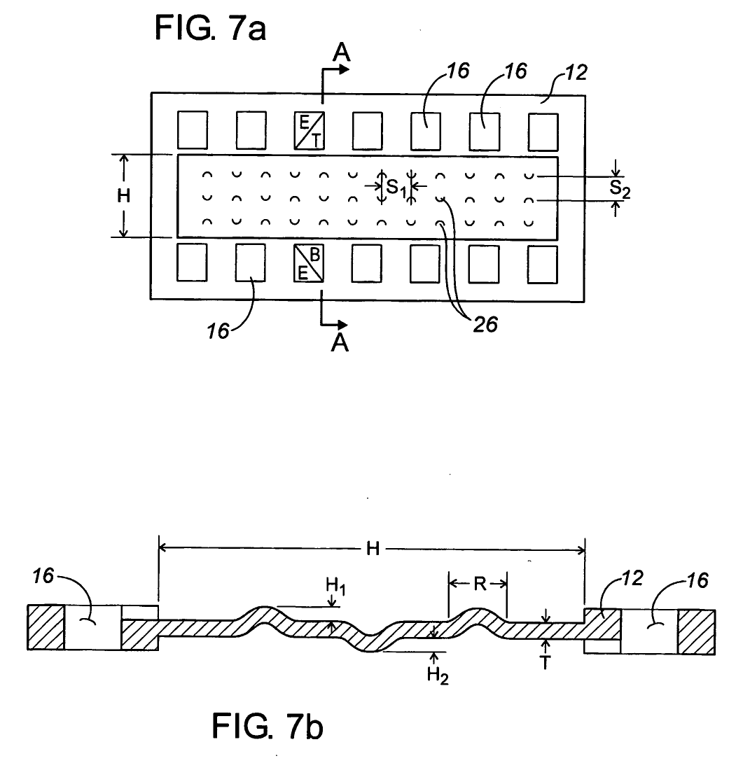

In FIGS. 3a and 3b, the ribbed structure shown for the metallic interconnect element 12 provides both the means to achieve interior interconnects 14, which may reduce cell electrical resistance or provide additional mechanical support to the cell or both, and the means to maintain open gas flow channels 15 that are connected to and communicate with the gas supply and exhaust manifolds 16. The metallic interconnect element 12 may incorporate any pattern of raised or depressed ridges and/or dimples so long as these accomplish the purpose of maintaining unrestricted gas flow channels to and from the electrode surfaces and communicate effectively with the gas supply and exhaust manifolds. Preferred patterns of ridges and dimples are those that readily permit the metallic interconnect element 12 to be formed most economically, such as by stamping from a thin metal sheet, and provide ease of interconnection and communication with the gas supply and exhaust manifolds. For these reasons, a dimpled pattern of bumps is preferred, wherein each side of the metallic interconnect element has a pattern of raised bumps, and the dimple pattern on one side of the metallic interconnect element 12 is offset from, and interspersed with, the dimple pattern on the other side of the metallic interconnect element 12. Such a dimpled metallic interconnect element 12 is illustrated in FIGS. 7a, 7b, where dimensions S1 and S2 are largely dependent on dimension T and typically range from about 1 mm to about 20 mm. More preferably dimensions S1 an S2 range from about 2 mm to about 10 mm.

It should also be noted that the gas supply and exhaust manifolds 16, as shown in FIGS. 3a, 3b, 4a, and 4b, are arranged for schematic simplicity only, such that the functioning of the metallic interconnect elements 12 might be more clearly illustrated. The preferred arrangement for the gas supply and exhaust manifolds 16 is to integrate them as axial channels located around but inside the perimeter of the reactor. This manifolding arrangement is conventionally known as internal manifolding and is illustrated in the design of the dimpled metallic interconnect element shown in FIGS. 7a, 7b.

The operation of the metal-supported solid electrolyte electrochemical cell of the present invention is fundamentally the same as for conventional solid electrolyte electrochemical cells. However, the details of the ionic conductor pathway and in particular of the electronic conductor pathway from the cathode to the anode differ. To illustrate, consider the example where a cell of the present invention is operated as a solid oxide fuel cell wherein the central electrolyte layer is exclusively an ionic conductor and the outer electrolyte layers are mixed ionic and electronic conductors. Further, let it be assumed that the first outer electrolyte layer is in contact with an oxygen rich gas and the second outer electrolyte layer is in contact with a fuel gas such as hydrogen. Consequently, the first outer electrolyte layer in combination with the first electrically conductive interface and the first metallic layer operates as the cathode electrode, and the second outer electrolyte layer in combination with the second electrically conductive interface and the second metallic layer operates as the anode electrode. As the first outer electrolyte layer is a mixed conductor, electrons, oxygen ions and adsorbed oxygen gas can come into intimate contact at all points on its surface. Likewise, as the second outer electrolyte layer is a mixed conductor, electrons, oxygen ions and adsorbed hydrogen fuel gas can come into intimate contact at all points on its surface. On the cathode side, electrons migrate from the underlying first metallic layer through the first electronically conductive interface and through the thickness of the first outer electrolyte layer to the surface of the first outer electrolyte layer where they combine with and ionize adsorbed oxygen. The oxygen ions then migrate along the first outer electrolyte layer until they pass through the first ionically conductive interface and into the central electrolyte membrane where the central electrolyte membrane contacts the first outer electrolyte layer at the first pattern of perforations in the first metallic layer. The oxygen ions then migrate through the central electrolyte layer and enter the second outer electrolyte layer through the second ionically conductive interface where the second outer electrolyte layer contacts the central electrolyte membrane at the second pattern of perforations in the second metallic layer. The oxygen ions then migrate to the surface of the second outer electrolyte layer where they come into contact with and react with the adsorbed hydrogen fuel gas liberating two electrons. These electrons then migrate through the thickness of the second outer electrolyte layer and through the second electronically conductive interface and into the second metallic layer. Once in the second metallic layer these electrons then migrate back to the first metallic layer through an external electrical circuit (not shown).

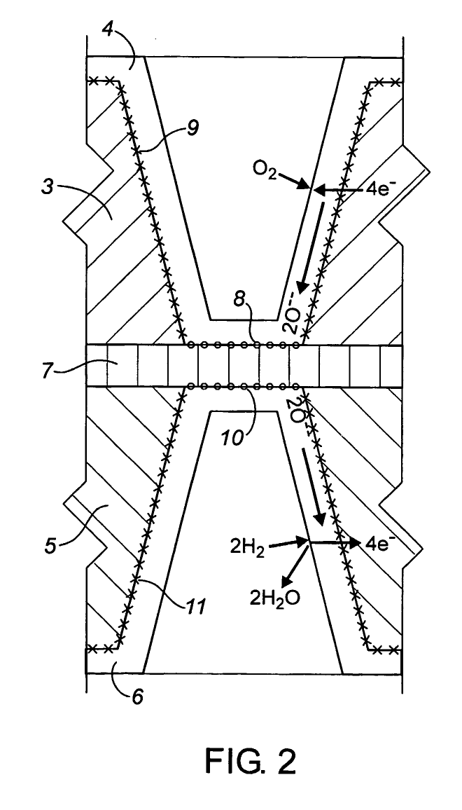

FIG. 2 shows an schematic expanded cross sectional view of a metal-supported solid electrolyte electrochemical cell and illustrative reactions and conductor paths for such a cell operating as a solid oxide fuel cell. As illustrated, the first metallic layer 3, in combination with the first outer electrolyte layer 4 and the first electrically conductive interface 9, operate as the cathode electrode. The second metallic layer 5, in combination with the second outer electrolyte layer 6 and the second electrically conductive interface 11, operate as the anode electrode. Oxygen ions form on the surface of, and migrate through, the first outer electrolyte layer 4, pass into the central electrolyte membrane 7 through the first ionically conductive interface 8, travel through the central electrolyte membrane 7, pass through the second ionically conductive interface 10 into the second outer electrolyte layer 6, and migrate to the surface of the second electrolyte layer where they react with fuel gas to liberate their surplus electrons. The electrons liberated on the surface of the second outer electrolyte layer 6 migrate into the second metallic layer 5 through the second electrically conductive interface 1, travel by an external electrical circuit (not shown) connecting the second metallic layer 5 to the first metallic layer 3, pass into the first outer electrolyte layer 4 through the first electrically conductive interface 9, and migrate to the surface of the first outer electrolyte layer 4 where they combine with adsorbed oxygen to form oxygen ions. The outer electrolyte layers are preferably mixed ionic and electronic conductors. However, if the outer electrolyte layer is thin enough such that electrons can tunnel through to the electrically conductive interface then the outer electrolyte layers may exhibit only ionic conductivity. To achieve stable and robust ionically conductive pathways through the cell, the first and second ionically conductive interfaces should provide continuous, intimate and adherent contact between the outer electrolyte layers and the central electrolyte membrane, and the first and second outer electrolyte layers should be dense and crack free. These are key challenges in building the metal-supported cell. Similarly, the integrity of the first and second electrically conductive interfaces is critical to achieving reduced electrical resistance for the cell and is a very important consideration in selecting materials for the first and second metallic layers.

### c) Description of Second Embodiment

In a second embodiment of the invention, the metal-supported solid electrolyte electrochemical cell includes a central electrolyte membrane defining two major surfaces, one major surface on each side of the electrolyte membrane. Adhered to one major surface of the central electrolyte membrane is a first porous inner electrolyte layer. To that surface of the first porous inner electrolyte layer which is not adhered to the central electrolyte membrane, is adhered a first metallic layer which incorporates a first pattern of perforations. The interface between the central electrolyte membrane and the first porous inner electrolyte layer defines a first inner ionically conductive interface. The interface between the first porous inner electrolyte layer and the first metallic layer defines a first inner electrically conductive interface. Adhered to the other major surface of the central electrolyte membrane is a second porous inner electrolyte layer. To that surface of the second porous inner electrolyte layer not adhered to the central electrolyte membrane is adhered a second metallic layer, said second metallic layer incorporating a second pattern of perforations. The interface between the central electrolyte membrane and the second porous inner electrolyte layer defines a second inner ionically conductive interface. The interface between the second porous inner electrolyte layer and the second metallic layer defines a second inner electrically conductive interface. Adhered to the outer surface, that is the surface which is not adhered to the first porous inner electrolyte layer, of the first metallic layer may or may not be a first outer electrolyte layer which makes intimate contact with the first porous inner electrolyte layer where such porous electrolyte layer is exposed by the first pattern of perforations. The interface between the first outer electrolyte layer and the first porous inner electrolyte layer defines a first porous ionically conductive interface. The interface between the first metallic layer and the first outer electrolyte layer defines a first electrically conductive interface. Adhered to the outer surface, that is the surface which is not adhered to the second porous inner electrolyte layer, of the second metallic layer may or may not be a second outer electrolyte layer which makes intimate contact with the second porous inner electrolyte layer where such porous electrolyte layer is exposed by the second pattern of perforations. The interface between the second outer electrolyte layer and the second porous inner electrolyte layer defines a second porous ionically conductive interface. The interface between the second metallic layer and the second outer electrolyte layer defines a second electrically conductive interface.

The cell is completed by providing metallic interconnect elements, including gas seals and electrical interconnects, to conduct reacting gases to and from each side of the metal-supported solid electrolyte membrane and to electrically connect the first metallic layer to the second metallic layer through an external electrical circuit. The central electrolyte membrane, the first porous inner electrolyte layer, the second porous inner electrolyte layer, the first outer electrolyte layer and the second outer electrolyte layer may be comprised of exclusively ionic conductors or of mixed ionic and electronic conductors. The central electrolyte membrane, the first porous inner electrolyte layer, the second porous inner electrolyte layer, the first outer electrolyte layer and the second outer electrolyte layer may each be formed of a single electrolyte material, a mixture of different electrolyte materials, a layered composite of different electrolyte materials, or a combination of the foregoing. Preferably, the first and second porous inner electrolyte layers and the first and second outer electrolyte layers are each formed of one or more electrolyte phases that exhibit both ionic and electronic conductivity, or are each formed of a multi phase mixture of one or more predominantly ionically conducting and one or more predominantly electronically conducting phases, or each are formed of a combination of the foregoing. The first and second porous inner electrolyte layers and the first and second porous ionically conductive interfaces are designed to be gas permeable to permit ready transport of reacting gases into, through and out of the porous inner electrolyte layers.

In accordance with this second embodiment of the invention, the fundamental operation of a metal-supported solid electrolyte electrochemical cell incorporating porous inner electrolyte layers is similar to that of conventional solid electrolyte electrochemical cells. However, the details of the electrode structures differ.

To illustrate, consider the example where a cell of the present invention is operated as a solid oxide fuel cell wherein the central electrolyte membrane is exclusively an ionic conductor and the porous inner electrolyte layers are mixed ionic and electronic conductors. For simplicity, assume that the cell does not incorporate outer electrolyte layers. Further, let it be assumed that the first metallic layer and the first porous inner electrolyte layer are in contact with an oxygen rich gas and the second metallic layer and the first porous inner electrolyte layer are in contact with a fuel gas such as hydrogen. Consequently, the first porous inner electrolyte layer in combination with the first metallic layer and its first pattern of perforations, the first inner ionically conductive interface and the first inner electrically conductive interface function as the cathode electrode. The second porous inner electrolyte layer in combination with the second metallic layer and its second pattern of perforations, the second inner ionically conductive interface and the second inner electrically conductive interface function as the anode electrode. Oxygen gas enters and exits the first porous inner electrolyte layer through the first pattern of perforations. As the first porous inner electrolyte layer is a mixed conductor, electrons, oxygen ions and adsorbed oxygen gas can come into intimate contact at many points throughout its bulk and at both the first inner ionically conductive and the first inner electrically conductive interfaces. Likewise, hydrogen fuel gas and water vapour enter and exit the second porous inner electrolyte layer through the second pattern of perforations. As the second porous inner electrolyte layer is a mixed conductor, electrons, oxygen ions and adsorbed hydrogen fuel gas can come into intimate contact at many points throughout its bulk and at both the second inner ionically conductive and the second inner electrically conductive interfaces. Where the thickness of the central electrolyte membrane and each of the porous inner electrolyte layers is kept short, each less than about 5 μm, the electrode structures of the present invention provide a high density of electrochemically active sites in combination with both short ionic and electronic conductor path length producing both high area specific current density and low internal resistive losses. In addition to providing a high density of electrochemically active sites the porous inner electrolyte layers provide the means to accommodate mismatches in thermal coefficients of expansion between the materials used for the ceramic electrolyte layers and the materials used for the metallic layers.

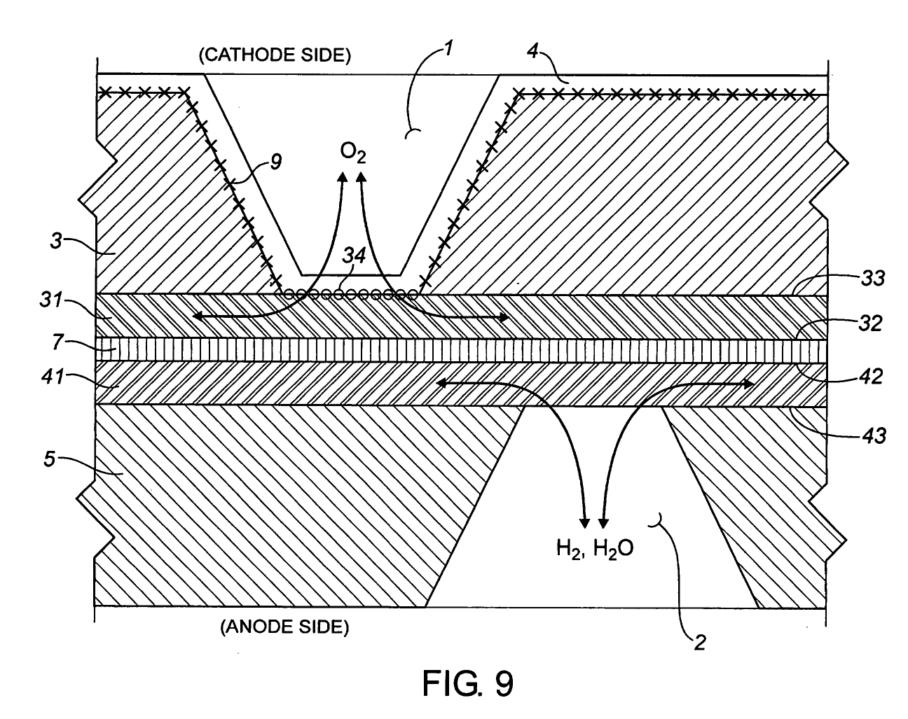

The second embodiment of the invention is shown generally in FIG. 9, and described in greater detail below, with like reference numerals being used to refer to like features from the first embodiment of FIG. 1-FIG. 7.

FIG. 9 shows a schematic expanded cross sectional view of a metal-supported solid electrolyte electrochemical cell operating as a solid oxide fuel cell and incorporating both first and second porous inner electrolyte layers, a first outer electrolyte layer but no second outer electrolyte layer. As illustrated, the first porous inner electrolyte layer 31 in combination with the first metallic layer 3 and its first pattern of perforations 1, the first outer electrolyte layer 4, the first inner ionically conductive interface 32, the first inner electrically conductive interface 33, the first porous ionically conductive interface 34, and the first electrically conductive interface 9 function as the cathode electrode. The second porous inner electrolyte layer 41 in combination with the second metallic layer 5 and its second pattern of perforations 2, the second inner ionically conductive interface 42 and the second inner electrically conductive interface 43 together function as the anode electrode. On the cathode side, oxygen gas is adsorbed onto the surface of the outer electrolyte layer 4 and also diffuses into and out of the first porous inner electrolyte layer 31, through the first pattern of perforations 1 and the first porous ionically conductive interface 34. As illustrated, hydrogen fuel gas and water vapour diffuse into and out of the second porous electrolyte layer 41 through the second pattern of perforations 2. The central electrolyte membrane 7 is designed to be gas impermeable and, since what is illustrated is a solid oxide fuel cell, to have good oxygen ion conductivity but ideally no electronic conductivity. To achieve stable and robust ionically conductive pathways through the cell, the first and second inner ionically conductive interfaces should provide continuous, intimate and adherent contact between the porous inner electrolyte layers and the central electrolyte membrane. Likewise, the integrity of the first and second inner electrically conductive interfaces is critical to achieving reduced electrical resistance for the cell and is a very important consideration in selecting materials for the first and second metallic layers.

It should be noted that while the details shown in FIG. 1a-7b and associated descriptions illustrate only metal-supported solid electrolyte electrochemical cells without porous inner electrolyte layers such details also apply to metal-supported solid electrolyte electrochemical cells incorporating porous inner electrolyte layers.

A range of ceramic electrolyte materials and metallic materials from which the metal-supported electrochemical cell described herein can be constructed are already known in the art. However, it will be recognized that the cell and multi cell reactor designs described herein can readily incorporate new and improved electrolyte and metallic materials.

Electrolyte Materials

The primary considerations in selecting electrolyte materials are that they be stable at the cell operating conditions and that they achieve the highest possible ionic conductivity at the lowest operating temperature. As used herein, in reference to electrolyte or metallic materials, “stability” refers to a material's ability to remain unchanged chemically and/or microstructurally during cell manufacture and operation, including its ability to resist continued interdiffusion and reaction with other materials to which is may be bonded and/or contacted, and to resist undesirable chemical reactions with gaseous atmospheres. For the cells described herein, operating temperatures are intended to be less than about 800° C. and operating temperatures at or below 650° C. are preferred since this lower temperature regime increases the selection and extends the life of the candidate materials that may be used both for the metallic layers in the cell itself and for metallic gas manifolds and metallic interconnect elements. Layered composites of more that one electrolyte material may be used to advantage by, for example, sandwiching a layer of a more ionically conductive but less stable material between two layers of a more stable but less ionically conductive material to provide a net increase in ionic conductivity with no loss in stability. For example, such layered composite electrolytes are described in U.S. Pat. No. 5,725,965. As used to produce the metal-supported solid electrolyte electrochemical cells described herein, electrolyte materials are in the form of thin films and/or coatings. Most preferably these thin films and/or coatings are dense and free of cracks.

Generally, any ionically conductive solid may be used as an electrolyte material in the metal-supported solid electrolyte electrochemical cells described herein. The electrolyte material may conduct one or more ionic species and each such ionic species may carry either a positive or negative electrical charge. Examples of such ionic species include oxygen ions (O⁻), hydrogen ions (H⁺) and sodium ions (Na⁺). Preferred electrolyte materials for the electrochemical cells described herein are oxygen ion conductors or mixed oxygen ion and electronic conductors. Minh and Takahashi, Science and Technology of Ceramic Fuel Cells, Elsevier, 1995, chapters 3, 4 and 5, teach useful examples of suitable oxygen ion conducting electrolyte materials. Representative oxygen ion or mixed oxygen ion and electronic conducting materials include fully stabilized zirconia, partially stabilized zirconia, doped ceria, doped bismuth oxide, perovskite oxides such as La_{0.8}Sr_{0.2}Ga_{0.85}Mg_{0.15}O_{2.825} and the like, and pyrochlore oxides such as Gd₂(Zr_{0.6}Ti_{0.4})₂O₇ and the like. Where the first porous inner electrolyte layer, and/or the second porous inner electrolyte layer, and/or the first outer electrolyte layer, and/or the second outer electrolyte layer contain predominantly electronically conductive phases these may comprise electronically conductive ceramics such as mixed metal oxides or single metal oxides, metals or combinations of electronically conductive ceramics and metals. Representative electronically conductive materials include perovskite oxides such as La_{0.9}Sr_{0.1}MnO₃ and La_{0.9}Sr_{0.1}CrO₃, oxides of silver and metals such as platinum, palladium and silver.

Materials for First and Second Metallic Layers

There are several important criteria for selecting materials for the first and second metallic layers. First, the coefficient of thermal expansion of the metallic material must be matched as closely as possible to that of the chosen electrolyte materials so as to minimize stresses that might cause the cell to delaminate. The metallic material must exhibit adequate electrical conductivity through its bulk and in particular at and through its surface especially where the metallic material inherently includes a surface oxide layer. The metallic material must provide adequate strength at the intended cell operating temperature. The metallic material should be stable under the cell operating conditions so as to provide long operating life. Ideally, the metallic material should also be low cost both from a commodity cost and from a processing cost standpoint. For the first and second metallic layers, stability primarily refers to the ability to resist oxidation at the desired operating temperature for the cell. While it is not necessary that the material selected for the first metallic layer be the same as the material selected for the second metallic layer, it is preferred that they be the same to simplify the design of the interfaces between dissimilar materials within the cell.

Representative materials for the first and second metallic layers include: nickel, gold, silver, platinum, chromium, chromium-iron alloys, ferritic stainless steels, austenitic stainless steels, nickel based super alloys, titanium and titanium alloys. Preferred metallic materials include chromium-iron alloys, ferritic stainless steels, austenitic stainless steels and nickel based super alloys. Where stabilized zirconia and/or doped ceria are uses as the electrolyte materials, the most preferred metallic materials include chromium-iron alloys and ferritic stainless steels. As more generally determined from a cost standpoint, the most preferred materials include ferrittic stainless steels and austenitic stainless steels.

As used to produce the first and/or second metallic layer described herein, metallic materials may be in the form of wrought foils, thin films, coatings and/or combinations of the foregoing. Metallic layers in the form of thin films or coatings may be produced by a range of coating processes including sputtering, chemical vapour deposition, electroless plating, electro plating, screen printing plus sintering, slurry coating plus sintering and tape lamination plus sintering. Preferably a wrought foil comprises the major part of at least one of the first metallic layer or the second metallic layer. Most preferably a wrought foil comprises the major part of both the first and second metallic layers.

Materials for the Metallic Interconnect Elements

The criteria for selecting materials for the metallic interconnect elements are similar to the criteria already described for selecting materials for the first and second metallic layers. However, for the metallic interconnect elements 12, the requirement to closely match the coefficient of thermal expansion to that of the electrolytes used is relaxed. Also, the material of the metallic interconnect elements must be compatible with the material of the first and second metallic layers with respect to the metallurgical bonding techniques used to join these materials. Representative materials for the metallic interconnect elements include: nickel, gold, silver, platinum, chromium-iron alloys, ferritic stainless steels, austenitic stainless steels, nickel based super alloys, titanium and titanium alloys. Preferred materials include ferritic stainless steels, austenitic stainless steels and nickel based super alloys.

As used to produce the metallic interconnect elements 12 described herein, metallic materials may be in the form of wrought foils, wrought thin sheets, wrought thin strip, castings and/or combinations of the foregoing. The preferred forms are wrought foils and/or wrought thin sheets.

Thickness Considerations

The central electrolyte membrane is preferably made as thin as possible to reduce stresses that tend to cause the cell to delaminate as a consequence of mismatches between the thermal expansion coefficient of the central electrolyte membrane and the thermal expansion coefficient of the first and/or second metallic layers. It is also desirable in certain arrangements of the first and second pattern of perforations to make the central electrolyte membrane as thin as possible to achieve the shortest possible ionic conductor path from one side of the membrane to the other. On the other hand, it is more difficult to achieve reliable electrical isolation between the first and second metallic layers when the central electrolyte membrane is less than about 0.5 μm thick. This is especially the case where the surface roughness of the first and/or second metallic layers, on those surfaces to which the central electrolyte membrane is adhered, is of the same magnitude as the thickness of the central electrolyte membrane. The thickness of the central electrolyte membrane is also dependent on the characteristics of the manufacturing process by which it is made. For example, if the central electrolyte membrane is formed by sputtering a film of the electrolyte material onto one of the metallic layers then it becomes more difficult to manage residual stresses in this electrolyte film as the thickness of the film increases beyond about 1 micron. Considering the foregoing factors, the thickness of the central electrolyte membrane preferably ranges from about 0.5 μm to about 10 μm and most preferably ranges from about 0.8 μm to about 5 μm.

The first and second porous inner electrolyte layers are preferably as thin as possible in order to provide the shortest possible ionic conductor pathway through the cell. At the same time, these porous layers should be thick enough to provide adequately large gas flow pathways throughout their bulk to permit unrestricted flow of the reacting gases. Considering these factors the thickness of the first and/or second porous inner electrolyte layers ranges from about 0.5 μm to about 10 μm and more preferably ranges from about 1 micron to about 5 μm.

At least one of the first metallic layer and the second metallic layer provides the mechanical support for the cell, i.e., one of these layers must be the supporting metallic layer, and is typically at least 2 times, and preferably at least 4 times, thicker than the central electrolyte membrane, such that the complete cell structure behaves mechanically as though it is were made entirely of metal. The desire to achieve a mechanically more robust cell, unless achieved by providing more bonding points to a stiff metallic interconnect element, also requires that the thickness of at least one of the first or second metallic layers be increased. It is also easier to achieve satisfactory metallurgical bonds between the first and or second metallic layers and the metallic interconnect elements when the thickness of the first and second metallic layers is greater than about 10 μm. The desire to reduce electronic resistance in the cell, which is important in solid oxide fuel cell applications, also calls for thicker metallic layers, but in this case both metallic layers are thicker. Electronic resistance in the metallic layers is determined by the spacing between electrical connections to the metallic interconnect elements and by the thickness and electronic conductivity of the first and second inner electrically conductive interfaces and/or the first and second electrically conductive interfaces. From the standpoint of electrical resistance in the cell, it is desirable that the electrically conductive interfaces be as thin as possible. On the other hand, it is much easier to provide a high density of perforations, resulting in better electrode gas flow performance and/or shorter average ionic conductor path length and increased current density for the cell, if both the first and second metallic layers are kept as thin as possible. Considering the foregoing factors, the thickness of the first metallic layer and the second metallic layer preferably ranges from about 5 μm to about 75 μm and most preferably ranges from about 10 μm to about 30 μm.

To minimize ionic resistance in the cell that does not incorporate porous inner electrolyte layers it is desirable to increase the thickness of both the first and second outer electrolyte layers as this provides an increased ionic conductor cross sectional area. This is especially important where the density of the patterns of perforations through the first and second metallic layers is reduced, as can result when these metallic layers are thicker than about 30 μm. It is also desirable that the outer electrolyte layers be thicker to provide increased protection to the underlying metallic layers against attack by the operating atmospheres in the cell. On the other hand, it is desirable to keep the outer electrolyte layers as thin as possible to minimize the delamination stresses that could cause then to spall off. Considering the foregoing factors, the thickness of the first and second outer electrolyte layers preferably ranges from about 0.1 μm to about 4 μm and most preferably ranges from about 0.2 μm to about 2 μm.

Referring to FIG. 7, it can be seen that the total thickness of the metallic interconnect element is made up of the sum of the height of the bumps or ribs on the top side of the element, dimension H1, the height of the bumps or ribs on the bottom side of the element, dimension H2, and the thickness of the metallic sheet from which the element is made, dimension T. Dimensions H1 and H2 are determined in relation to the size of gas flow channel required to handle the design gas flows to and from the cell electrode surfaces, which is directly proportional to the width of the active cell area, dimension H, and by whether or not a stiff porous support material is inserted into the gas flow channels to provide additional support to the electrochemical cells. H1 and H2 need not be the same, although it is desirable for simplicity that they be so. Typically, H1 and H2 range from about 0.2 mm to about 3 mm and preferably range from about 0.2 mm to about 1 mm. Typically, T ranges from about 0.1 mm to about 2 mm and preferably from about 0.1 mm to about 1 mm. Therefore, the overall thickness of the metallic interconnect elements typically ranges from about 0.5 mm to about 8 mm and preferably ranges from about 0.5 mm to about 3 mm.

Pattern of Perforations

The functions of the first and second pattern of perforations are to provide gas access to the porous inner electrolyte layers, or to expose the central electrolyte membrane such that the outer electrolyte layers make intimate contact with the central electrolyte membrane, and thus complete an ionic, conductor path through the cell (i.e., from one side of the central electrolyte membrane to the other). The individual perforations may be of any size and shape providing that adequate structural support is provided to the central electrolyte membrane by the first and/or second metallic layers and that the metallic layers, incorporating the perforations, have sufficiently large metallic conductor pathways to provide low electrical resistance to the cell. The arrangement of the patterns, including the density of perforations per unit area of cell surface, may be varied from one area to another over the surface of the first and/or second metallic layers. The first pattern of perforations may be the same as or different from the second pattern of perforations. To maximize electrode gas flow performance and/or to minimize ionic conductor path lengths and thus maximize ionic current through the cell, the size of individual perforations should be small, and the density of perforations per unit area of cell surface, on both the first and second metallic layers, should be as high as possible. The side walls of the individual perforations are preferably, but not necessarily, approximately perpendicular to the surface of the central electrolyte membrane since this permits a greater density of perforations per unit of surface area and provides larger, lower resistance electronic conductor paths for a given perforation shape and pattern density.

Representative Manufacturing Processes

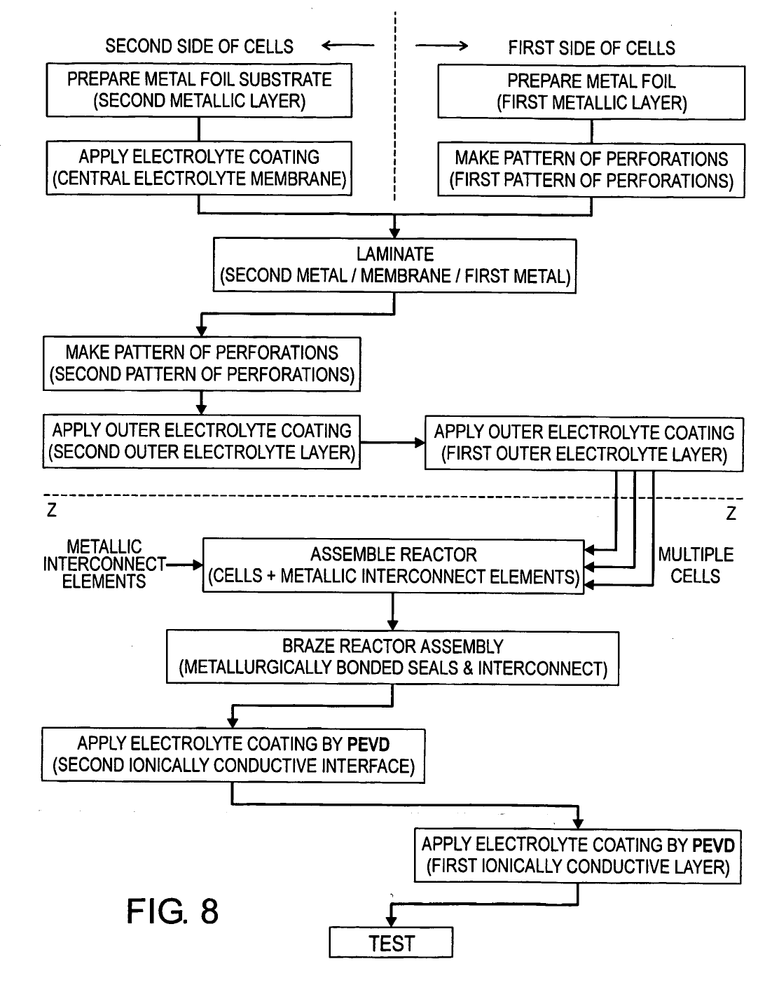

FIG. 8 is a flow chart of a representative manufacturing process to produce a reactor incorporating multiple metal-supported solid electrolyte electrochemical cells of the first embodiment of this invention, which cells do not incorporate porous inner electrolyte layers. Process operations shown on the left side of the page apply to producing the second metallic layer, the second pattern of perforations, the second outer electrolyte layer and the second ionically conductive interface. The process operation that produces the central electrolyte membrane is also shown on the left side of the page. Process operations shown on the right side of the page apply to producing the first metallic layer, the first pattern of perforations, the first outer electrolyte layer and the first ionically conductive interface. Process operations shown centred on the vertical centre of the page apply to the whole cell or to the whole reactor assembly. Process operations shown above the horizontal broken line at Z-Z apply to individual cell production and those operations shown below the line Z-Z apply to multi cell reactor production. It is clear from FIG. 8 is that the production of individual cells involves a number of sequential lamination, coating or film-forming process operations that build up a five-layered laminated structure interspersed with process operations to remove metallic material to form the perforation patterns. The overall manufacturing process is similar to the overall manufacturing processes used in the electronics industry to produce double sided printed circuit boards and in particular to produce double-sided flexible printed circuits.

The metallic layers may be provided, as is shown in FIG. 8, as wrought foils and this is preferred as it permits ready control over the composition and mechanical properties of the metallic materials. However, if both metallic layers are formed from wrought foils a process must be provided to laminate at least one of the metallic layers to the ceramic central electrolyte membrane. Also, a process must be provided to remove material from the foils to produce the patterns of perforations. Representative processes to provide the pattern of perforations include a range of photolithographic and chemical etching processes such as those used to produce printed circuit boards or, more particularly, such as those used in the photochemical machining industry to produce miniature components from stainless steel materials. These same patterning or photochemical machining processes may also be used in the manufacture of the metallic interconnect elements. A preferred process which provides that both the first and second metallic layers are provided as wrought foils is summarized in FIG. 8, wherein one foil is first provided with an appropriate pattern of perforations while the other is coated with a pre-fired “loaded sol-gel” coating of the electrolyte material that will form the central electrolyte membrane. The two foils are then pressed together such that the continuous foil and the perforated foil sandwich the pre-fired “loaded sol-gel” electrolyte coating. Upon firing the “loaded so-gel” coating densifies and bonds to both the continuous foil and to the perforated foil. The perforations in the perforated foil provide a means of escape for the volatile organics that evolve during firing of the “loaded sol-gel” coating. A suitable “loaded sol-gel” coating process is described in U.S. Pat. No. 5,585,136. Alternatively, a multi layered combination of a “loaded sol-gel” and a (conventional) sol-gel process may be used. Representative sol-gel processes are described in U.S. Pat. No. 5,494,700.

Alternatively, the first and/or the second metallic layers may be produced by either single or multiple coating and/or plating processes. The principal disadvantage of this approach is that the degree of control over the composition and mechanical properties of the metallic layers is reduced. The advantages of this approach are that: the pattern of perforations may be formed as the metallic layers themselves are produced, thus eliminating the need for a separate patterning process; a high density of perforations is achievable even where the metallic layer is thicker than 10 μm; and the side-walls of individual perforations can be made approximately perpendicular to the surface of the central electrolyte membrane. Representative processes include electroless plating, electroplating of metals and alloys, DC magnetron sputtering of metals and alloys, and combinations thereof. A representative process to produce densely packed steep-walled vias or perforations in tick metal layers is described in Leith and Schwartz, High-Rate Through-Mold Electrodeposition of Thick (>200 mm) NiFe MEMS Components with Uniform Composition, Journal of Microelectromechanical Systems, Vol. 8, No.4, December 1999. The first and/or second metallic layer may also be provided by a range of processes that involve applying the metal or alloy as a powder, typically held in a polymeric binder, and subsequently sintering the powder to produce a dense monolithic metallic layer. Representative processes for providing the pre-sintered metallic layer are screen printing, slurry coating and tape casting/lamination.

In addition to the sol-gel and “loaded sol-gel” coating processes already referenced herein, the central electrolyte membrane and the outer electrolyte layers may be produced by any process that produces a satisfactory ceramic coating. Representative coating processes include reactive DC magnetron sputtering, RF magnetron sputtering and chemical vapour deposition. For example, representative DC and RF magnetron sputtering processes for depositing layers of yttria stabilized zirconia, a preferred electrolyte material for solid oxide fuel cells, are described in U.S. Pat. No. 5,753,385. Preferred processes for forming the central electrolyte membrane are by providing single layer or multi layer coatings by the “loaded sol-gel” process, already referenced herein, or by providing multi layer coatings that combine “loaded sol-gel” and sol-gel coatings. Preferred coating processes for forming the outer electrolyte layers include “loaded sol-gel,” sol-gel, polarized electrochemical vapour deposition (PEVD) and combinations thereof. The most preferred process to produce the outer electrolyte layers is to first apply a single or multi layer sol-gel coating followed by a PEVD coating. The PEVD process is described in Tang et al, A New Vapor Deposition Method to Form Composite Anodes for Solid Oxide Fuel Cells, Journal of the American Ceramics Society, 83[7] 1626-32 (2000). The advantage of the PEVD process is that it produces robust ionically conductive interfaces between the central electrolyte membrane and the outer electrolyte layers and also fills in cracks in the outer electrolyte layers, thus providing a robust ionic conductor path through the cell.

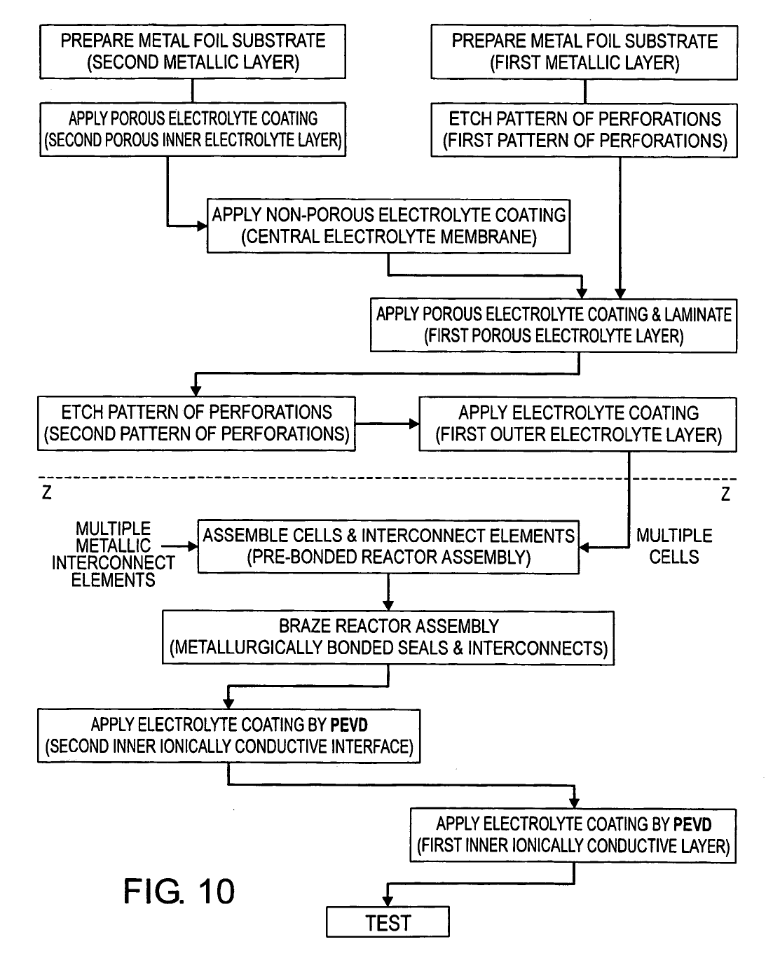

FIG. 10 is a flow chart of a representative manufacturing process to produce a reactor incorporating multiple metal-supported solid electrolyte electrochemical cells of the second embodiment of the invention, which cells incorporate porous inner electrolyte layers and a first outer electrolyte layer, but do not incorporate a second outer electrolyte layer. It should be noted that the inclusion of a first outer electrolyte layer and omission of a second outer electrolyte layer is done simply to illustrate that either or bot of these layers may be readily added or deleted from the overall manufacturing process. Process operations shown on the left side of the page apply to producing the second metallic layer, the second pattern of perforations, the second porous inner electrolyte layer and the second inner ionically conductive interface. Process operations shown on the right side of the page apply to producing the first metallic layer, the first pattern of perforations, the first porous inner electrolyte layer, the first outer electrolyte layer and the first inner ionically conductive interface. Process operations shown centred on the vertical centre of the page apply to production of the central electrolyte membrane for individual cells and of the whole reactor assembly. Process operations shown above the horizontal broken line at Z-Z apply to individual cell production and those operations shown below the line Z-Z apply to multi cell reactor production. The PEVD coating operations, of which the principal purpose is to strengthen the inner ionically conductive interfaces, are included to illustrate that they may be part of the overall manufacturing process if required. However, for cost minimization purposes it is desired and, particularly in the case of metal-supported solid electrolyte cells that incorporate porous inner electrolyte layers, expected that the PEVD process operations will not be required.

It is clear that the overall manufacturing process and individual process operations shown in FIG. 10 are the same as those shown in FIG. 8 with the exception of specific process operations required to produce the porous inner electrolyte layers. The porous inner electrolyte layers may be produced by any process that produces a suitable porous ceramic coating. Representative processes include suitably adapted tape casting and lamination, screen printing, reactive DC and RF sputtering, sol-gel, and “filled sol-gel” processes. A representative and broadly applicable adaptation used to achieve and/or enhance the porosity of coatings involves the inclusion a fugitive pore-forming filler material that is typically removed by a burn-out or leaching operation after the coating is formed. The “filled sol-gel” process already described herein lends itself very well to the production of porous multi phase ceramic electrolyte coatings and is a preferred method for manufacturing the porous inner electrolyte layers of the metal-supported solid electrolyte electrochemical cells described herein.

Modified Electrically Conductive Interfaces

In another embodiment of the metal-supported solid electrolyte electrochemical cell described herein, the first inner electrically conductive interface and/or the second inner electrically interface and/or the first electrically conductive interface and/or the second electrically conductive interface is modified, by the addition of particular metal layers, such that particular metal oxide compositions are formed that increase the electrical conductivity of the electrically conductive interface above what it would otherwise be and/or render it more stable at the cell operating conditions. Representative materials that may be used to increase the conductivity of the first and second inner electrically conductive interfaces and/or the first and second electrically conductive interfaces depend on the specific materials selected for the first and second metallic layers. Where the metallic layers are of a chromium rich alloy that forms a chromium oxide scale, representative metals such as manganese, magnesium and zinc may be incorporated to produce a modified surface oxide scale exhibiting increased electrical conductivity and stability. Manganese is a preferred material for use with chromium rich alloys. U.S. Pat. No. 6,054,231 describes suitable materials and processes for providing such a modified electrically conductive surface layer on chromium rich alloys for use on the anode facing side of metallic bipolar interconnect elements in solid oxide fuel cells. Such chromium rich alloys are also preferred materials for the first and second metallic layers of the metal-supported solid electrolyte electrochemical cells described herein. It is worth noting that the desired surface oxides may also be obtained by adding a sufficient concentration of the desired surface oxide modifying metal to the formulation of the alloy from which the first and/or second metallic layers are made. For example, 5% by weight or more of manganese might be added to a ferritic stainless steel. However, such changes to alloy formulation can change the thermal expansion characteristics quite markedly such that the alloy no longer presents a good match to the thermal expansion characteristic of the chosen electrolyte materials.

Metallurgically Bonded Gas Seals and/or Electrical Interconnects

In another preferred embodiment, the first metallic layer and the second metallic layer of the metal-supported solid electrolyte electrochemical cell are each metallurgically bonded to one or more metallic interconnect elements. As used herein, the terms “metallurgically bonding” or “metallurgically bonded” means joined by a welding or brazing process, and the term “metallurgical bond” means the joint formed by metallurgical bonding. The metallurgical bonding of the first and second metallic layers to the metallic interconnect elements may occur only at the cell periphery. Alternatively, to provide greater mechanical strength and/or lower electrical resistance to the cell, the first and second metallic layers may also be metallurgically bonded to the metallic interconnect elements at many points across their surface where these bonding points are arranged to minimize restrictions in the flow of gas to and from the electrode surfaces.

FIGS. 3a, 3b show a plan view and a sectional view of a representative schematic for a multi cell reactor incorporating metal-supported solid electrolyte electrochemical cells and metallic interconnect elements, which interconnect elements provide both series electrical interconnection between the stacked cells and gas flow channels to transport the relevant gases to and from the electrode surfaces. The peripheral gas seals and electrical interconnects 13 and/or the interior interconnects 14 between the first metallic layer 3 and/or the second metallic layer 5 and the metallic interconnect elements 12 may be made by metallurgically bonding the first metallic layer 3 and/or the second metallic layer 5 to the metallic interconnect element 12. FIGS. 4a, 4b show a detailed cross sectional view for the case where the peripheral gas seal and interconnect 13 is metallurgically bonded by a brazing technique and incorporates the braze filler metal 17. The central electrolyte membrane 7 preserves electrical isolation between the first metallic layer 3 and the second metallic layer 5 in making such a metallurgically bonded interconnect. Since this is easier to achieve by brazing than by welding techniques, brazing is the preferred metallurgical bonding process. The first pattern of perforations 1 and/or the second pattern of perforations 2 may extend under the braze filler metal since the width of the braze joint spans over many perforations and thus provides a reliable gas seal and/or electrical interconnections. While the metal-supported solid electrolyte electrochemical cells shown in FIGS. 4a, 4b do not incorporate porous inner electrolyte layers, it should be understood that the metallurgical bonding details illustrated in FIGS. 4a, 4b also apply to metal-supported solid electrolyte electrochemical cells incorporating such porous inner electrolyte layers.

Any metallurgical bonding process that results in the formation of a satisfactory metallic bond between the first and/or second metallic layers and the metallic interconnect elements may be used. The selection of the bonding process depends on the selection of the materials for the first and second metallic layers and for the metallic interconnect elements. In general, suitable metallurgical bonding processes include a variety of brazing and welding techniques, and combinations thereof. For many of the candidate metallic materials that may be used to build metal-supported solid electrolyte electrochemical cells, suitable metallurgical bonding processes are already practiced widely. For example, several welding and brazing processes for joining stainless steels, nickel alloys, titanium alloys and chromium-iron alloys are in widespread commercial use and these same processes can be used in the building of the metal-supported cells described herein. The preferred metallurgical bonding processes are vacuum brazing, inert atmosphere brazing, resistance welding and combinations thereof. The most preferred metallurgical bonding processes are vacuum brazing and/or inert atmosphere brazing because these processes provide minimal damage to the central electrolyte membrane of the cell, and provide a ready means to make metallurgical bonds at internal mating surfaces after the cells and metallic interconnect elements have been assembled, but not yet metallurgically bonded, into a multi cell reactor. For multi cell reactor assembly, braze filler metal may conveniently be provided to those areas to be metallurgically bonded in the form of preformed tapes, wire gaskets, foil gaskets, pastes or combinations of the foregoing.

Outer Electrolyte Over Metallurgical Bond

In another embodiment of the solid electrolyte electrochemical cell described herein, the first outer electrolyte layer and/or the second outer electrolyte layer extend over the area where the metallurgical bond occurs between the first and/or second metallic layers and the adjacent metallic interconnect elements. The outer electrolyte layers may also extend over all or a part of the surface of the metallic interconnect elements. The outer electrolyte layer, which is itself selected to be a stable ceramic, thus provides protection to all underlying metal surfaces that would otherwise be directly exposed to the cell's operating atmospheres. For example, the outer electrolyte layer can protect underlying metallic materials from oxidation, carburization and/or attack by sulphur compounds such as hydrogen sulphide gas. The preferred method for extending the outer electrolyte layers over the metallurgical bonding area is by the PEVD process already referenced herein as this is a modified chemical vapour deposition/coating process and can be carried out after the cell has been assembled into a multi cell reactor. The PEVD process is effective for this purpose since the bonding surface and any other metallic surface to be coated with the outer electrolyte layer are electronically conductive. The preferred process for extending the outer electrolyte layer over the surface of the metallic interconnect elements is to first apply a coating of the outer electrolyte material to the metallic interconnect elements on all surfaces, except those to be bonded to the first and/or second metallic layers of the cell, then to metallurgically bond the interconnect elements to the first and/or second metallic layers, and finally to complete the outer electrolyte layer by the PEVD process already described. The preferred method for applying the electrolyte coating to the metallic interconnect elements is by the sol-gel or loaded sol-gel techniques already described but any other method of applying ceramic coatings to dense metallic surfaces may also be used. This coating may have cracks and other minor discontinuities as these can be filled in by the subsequent PEVD coating process.

FIG. 4b, Detail C from FIG. 3b shows a metallurgically bonded gas seal and interconnect at the periphery of a metal-supported cell. It can be seen that both the first outer electrolyte layer 4 and the second outer electrolyte layer 6 extent over the metallurgical bonds 17 and those areas of the metallic interconnect elements 12 immediately adjacent to the metallurgical bonds 17.

Pattern of Perforations to Yield Robust Gas Impermeable Membrane

In another embodiment of the metal-supported solid electrolyte electrochemical cell described herein, the first pattern of perforations and the second pattern of perforations are so arranged such that the central solid electrolyte membrane or the laminated structure including the first porous inner electrolyte layer, the central electrolyte membrane and the second porous inner electrolyte, hereinafter referred to as the inner electrolyte sandwich, is everywhere supported directly by either the first metallic layer and/or the second metallic layer, providing a robust gas impermeable membrane. FIGS. 1a, 1b show such an arrangement of the first and second pattern of perforations where it can be seen that the central membrane 7 is everywhere in contact with and supported by either the first metallic layer 3 or the second metallic layer 5. Where the metallic layers are made relatively thick, preferably more than about 20 μm, and/or where the first and/or second metallic layers are metallurgically bonded to robust metallic interconnect elements at frequent intervals, preferable spaced at about 1.5 cm or less, then the cell is capable of withstanding significant differentials in pressure between one side and the other. Alternatively, the cell may be supported mechanically, at least on the low pressure side of the membrane, by being brought into contact with a stiff, gas permeable, perforated or porous or mesh-like metallic, ceramic or metal/ceramic composite element over its entire area. Such metal-supported cells with robust gas impermeable electrolyte membranes are particularly useful in electrically driven oxygen concentration reactors and in pressure driven partial oxidation reactors.

Pattern of Perforations to Yield Short Ionic Path

In another embodiment of the metal-supported solid electrolyte electrochemical cell not incorporating porous inner electrolyte layers described herein, the first pattern of perforations and the second pattern of perforations are arranged so as to define areas where the central solid electrolyte membrane is supported directly by neither the first metallic layer nor the second metallic layer, thus providing at these areas an ionic conduction path between each side of the cell that is defined only by the thickness of the central solid electrolyte membrane. By this approach it is possible to achieve ionic conductor path lengths of only a few μm which facilitates lower operating temperatures, increased current densities or both. FIGS. 5a, 5b show an example of such an arrangement of the first and second pattern of perforations where the perforations in both the first metallic layer 3 and the second metallic layer 5 are elongated in shape, for example where their length is about 5 times their breadth, and at the same time the first pattern of perforations 1 and the second patter of perforations 2 are deliberately arranged to be non-parallel thus defining areas where the central electrolyte membrane is not supported where the patterns overlap. Such an arrangement also greatly simplifies the task of aligning the first pattern of perforations and the second pattern of perforations which is very advantageous from a manufacturing standpoint.

Pattern of Perforations to Achieve Reduced Thermal Gradients in Individual Cells

In another embodiment of the metal-supported solid electrolyte electrochemical cell described herein, the first pattern of perforations and/or the second pattern of perforations are arranged so as to vary the electrochemical current density areally over the surface of the electrodes by varying the density of perforations from one area to another over the surface of the cell, as for example from the center to the edge. Thereby it is possible to reduce temperature gradients in the cell associated with areal variations in the concentration and/or the temperature of the reacting gasses over the electrode surfaces. In this manner it is possible to tailor the design of individual cells to match/compensate for the gas flow patterns associated with particular reactor designs.

Specialized Catalysts on the Electrodes

In another embodiment of the metal-supported solid electrolyte electrochemical cell described herein, specialized catalysts are incorporated onto or into the first porous inner electrolyte layer and/or the second porous inner electrolyte layer and/or the first outer electrolyte layer and/or the second outer electrolyte layer. For example, such catalysts may be selected to enhance certain preferred fuel gas reforming in a solid oxide fuel cell or particular oxidation reactions in a partial oxidation reactor. The catalyst must be present at those surfaces of the porous inner electrolyte layers and/or of the outer electrolyte layers that contact the reacting gases and must be present in such concentration that it provides the desired catalytic effect but does not crowd out or otherwise impair the cell's electrochemical reactions. These catalysts may be applied as very thin discontinuous metal and/or metallic oxide coatings on the surface of the outer electrolyte layers by such processes as RF or DC magnetron sputtering or chemical vapour deposition. The preferred approach is to incorporate the catalyst as a very finely dispersed oxide within the porous inner electrolyte layers and/or the outer electrolyte layers at the same time as these layers themselves are formed by the sol-gel and/or loaded sol-gel techniques already referenced herein. Suitable catalyst materials are well known in the art and include metals and oxides of metals selected from Groups II, V, VI, VII, VIII, IX, X, XI, XV and the F Block lanthanides of the Periodic Table of elements according to the International Union of Pure and Applied Chemistry. Particularly suitable materials include metals platinum, palladium, ruthenium, rhodium, gold, silver, bismuth, cerium, barium, vanadium, nickel, cobalt, manganese, molybdenum and praseodymium, and/or the oxides of these metals.

Preferred Reactor Design

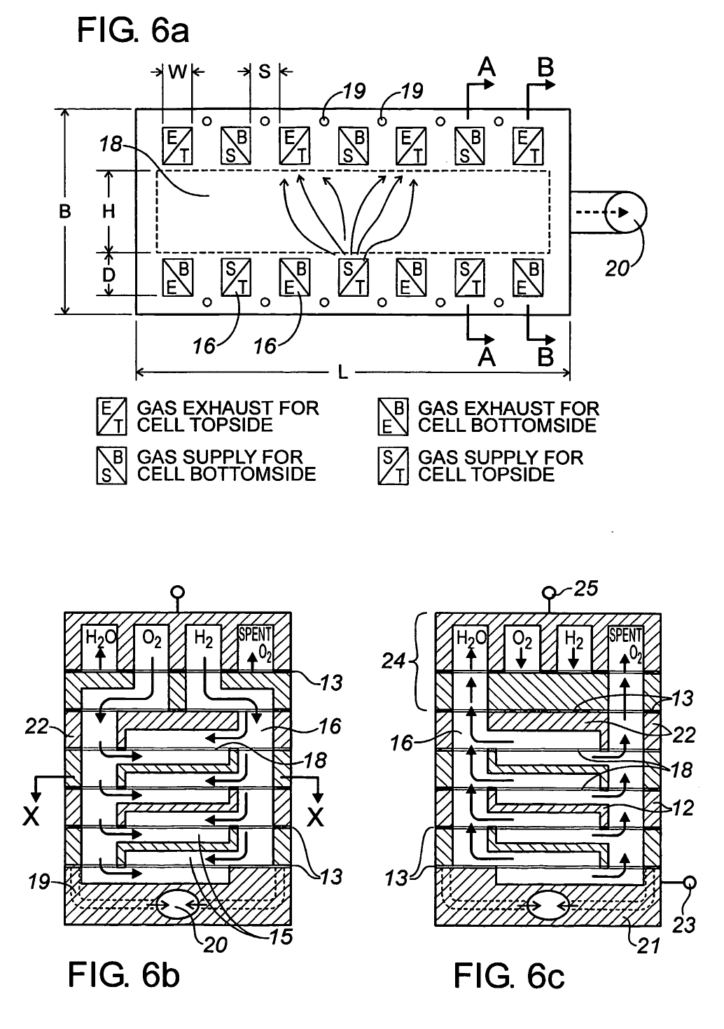

In another embodiment, a preferred design for a multi cell reactor incorporating multiple metal-supported solid electrolyte electrochemical cells is provided. Such a reactor can be used as a solid oxide fuel cell stack, an oxygen concentration reactor or a partial oxidation reactor. A schematic layout for such a reactor is presented in FIGS. 6a, 6b and 6c where in sectional views A-A (FIG. 6b)and B-B (FIG. 6c) individual cells 18, each incorporating a first outer electrolyte layer, a first pattern of perforations, a first electrically conductive interface, a first metallic layer, a first ionically conductive interface, a central electrolyte membrane, a second ionically conductive interface, a second metallic layer, a second pattern of perforations, a second electrically conductive interface and a second outer electrolyte layer, are connected in electrical series by metallic interconnect elements 12. Alternatively, the individual metal-supported cells 18 may each be comprised of a first metallic layer, a first pattern of perforations, a first inner electrically conductive interface, a first porous inner electrolyte layer, a first inner ionically conductive interface, a central electrolyte membrane, a second inner ionically conductive interface, a second porous inner electrolyte layer, a second inner electrically conductive interface, a second metallic layer and a second pattern of perforations and may or may not also incorporate a first porous ionically conductive interface and a first outer electrolyte layer and/or a second porous ionically conductive interface and a second outer electrolyte layer. The arrangement of the metal-supported cells 18, the metallic interconnect elements 12 and the peripheral gas seals and interconnects 13 is as previously described herein. It is preferred that at least the peripheral gas seals and interconnects 13 and alternatively any interior interconnects as well be metallurgically bonded.

The primary objective and feature of this reactor design is that it is readily scaleable, in that the active area of individual cells and/or the number of cells in the reactor can be increased without requiring changes to the dimensions or materials in the active area of the individual cells, which dimensions and materials govern the electrochemical performance of the cells. This is achieved in the rectangular cells shown in FIG. 6a by setting and holding constant the width of the active area of the cells, dimension H, which permits such parameters as the thickness of the first and second metallic layers, the design of the first and second pattern of perforations, the size and shape of individual perforations, the thickness of the central electrolyte membrane, the overall height of the metallic interconnect elements, the layout of the dimpled or ribbed pattern for the interconnect elements, and the gas flow communication between the manifolds and gas flow channels to be determined once and thereafter to be held constant. If the number of cells in the stack is increased then only dimensions B and D need to be increased to provide for enlarged gas manifolds 16 while all other dimensions remain unchanged. Likewise if the active area of the individual cells is expanded by expanding dimension L, all other dimension remain unchanged. It should be noted that ready expansion of dimension L is enabled by the metal-like mechanical characteristics of the metal-supported cells described herein and that such an expansion in dimension L would be very difficult to achieve using conventional solid electrolyte electrochemical cell designs since these exhibit ceramic-like mechanical characteristics. From a commercial standpoint, scaleability is a very important attribute as it permits the same basic cell design to be used in a broad range of different products, requiring reactors ranging widely in size, thus permitting more rapid progress towards large-volume, low-cost manufacturing for the reactors and at the same time providing for continued technical optimization of the basic cell design.

Preferably the dimension H ranges from about 10 mm to about 500 mm and most preferable ranges from about 20 mm to about 300 mm. Preferably dimension L ranges from about 50 mm to about 1,000 mm and most preferably ranges from about 100 mm to about 700 mm. Preferably the number of individual cells in the reactor ranges from about 10 to about 500 and most preferably ranges from about 20 to about 200.

While a counter flow gas manifolding arrangement as shown in FIG. 6a-6c is preferred, because it permits the gas supply manifolds to be interspersed with the gas exhaust manifolds thus providing for more effective preheating of the incoming gasses, the design may also be configured for a co-flow gas manifolding arrangement.

Optionally, the reactor may be provided with liquid heat transfer fluid channels 19 that run vertically through the height of the reactor and are located adjacent to the gas manifolds 16. Liquid heat transfer fluid is supplied from the reactor header block 24 and flows vertically down through the reactor and exits the reactor by the liquid heat transfer fluid return header 20. To maintain electrical isolation between the first metallic layer and the second metallic layer of the individual cells in the stack the liquid heat transfer fluid must not be an electrical conductor.

The reactor is also provided with a bottom end plate 21, a top section adaptor 22 and a reactor header block 24. The reactor header block 24 interconnects the vertical gas manifolds 16 and the vertical liquid heat transfer fluid channels 19 to supply and/or return headers that are external to the reactor. All such external supply and return headers are provided with electrical isolators to ensure that the only electrical connections to the reactor are by the bottom electrical terminal 23 and the top electrical terminal 25.

### EXAMPLES

### Example 1

A sheet of Haynes Alloy 230 2B annealed foil, 50 μm (0.002 inches) in thickness and obtained from Elgiloy Speciality Metals of Elgin, Ill., was coated with an approximately 5 μm thick yttria stabilized zirconia coating by a “loaded” sol-gel coating technique at Datec Coating Corporation of Milton, Ontario. The finished “loaded” sol-gel coating consisted of approximately 1 μm sized particles of yttria stabilized zirconia encapsulated in a continuous matrix of a yttria stabilized zirconia sol-gel coating. The 5 μm thick coating was applied in two layers, each about 2.5 μm thick. The layers were sprayed on wet and heat treated at less than 600° C. for about 10 minutes to crystalize the zirconia sol. This coated nickel based super alloy structure was thermally cycled by heating to 650° C. in air in a furnace and quenching to room temperature by rapid removal from the furnace. The laminate was cool to the touch within 5 seconds of removal from the furnace. The structure survived 5 cycles without evidence of delamination.

### Example 2

A piece of wrought Grade 430 stainless steel, cold roll temper, having a thickness of 25 μm, obtained from Hamilton Precision Metals Inc. of Lancaster Pa. and approximately 5 cm×9 cm in area, was prepared by heat treating in air at 550° C. for 30 minutes. A “loaded” sol-gel coating approximately 5 μm in thickness was applied to one side of the stainless steel foil as in Example 1. This structure demonstrated excellent adhesion when tested using a tape adhesion test consisting of applying transparent tape and removing by pulling at 90 degrees. The sample was thermally cycled, as described in Example 1, for 10 cycles without evidence of delamination. The sample was cool to the touch within 3 seconds of removal from the furnace confirming that its low thermal mass offered the potential to rapidly bring it to the target operating temperature for a solid oxide electrolyte based electrochemical cell. The tape adhesion test was repeated after the thermal cycling tests and again excellent adhesion of the “filled” sol-gel coating was observed. SEM images indicated that the coating contained micron-sized interconnected porosity.

### Example 3

A piece of wrought Grade 430 stainless steel foil, 25 μm thick and measuring approximately 3 cm×3 cm was patterned with elongated perforations, approximately 150 μm long by 15 μm wide and spaced at about 200 μm micron centres using photo lithography. The etchant used was ferric chloride. An unperforated piece of wrought Grade 430 stainless steel foil was coated with a 5 μm thick “loaded” sol-gel coating of yittria stabilized as in Example 1. A yttria zirconia sol was then sprayed on top of the “filled” sol-gel coating and the perforated foil was pressed to and held against the wet sol coating. This sandwich structure was then heat treated to crystalize the sol coating and simultaneously bond the laminated structure. This example demonstrated the feasibility of using low-temperature sol-gel based processes to build a complete electrochemical cell structure incorporating a metal foil as a supporting substrate and/or as part of both of the cell's electrodes.

### Example 4

A piece of wrought Grade 430 stainless steel as in Example 2 and having approximately 5 cm×3 cm in area was prepared by heat treating in air at 550° C. for 30 minutes. A “loaded” sol gel coating approximately 5 μm in thickness was applied to one side of the stainless steel foil as in Example 1. On top of the “loaded” sol-gel coating an approximately 7 μm thick of Grade 320 stainless steel was deposited by DC magnetron sputtering by Thin Film Technology, Inc. of Buellton, Calif. This sample was subjected to thermal cycling tests as in Example 1 and exhibited no delamination after 5 cycles.

### Example 5

A multilayer structure having a first metal layer consisting of a 25 μm thick Grade 430 wrought stainless steel foil was prepared as outlined in Example 2. A porous “loaded” sol gel coating of yttria stabilized zirconia, approximately 6 μm in thickness, was applied to one side of the stainless steel foil as in Example 1. To the top of this layer 5 coats of yttria containing zirconia sol were applied and heat treated to impregnate and seal the top approximately 3 μm of the “loaded” sol-gel coating. On top of this layer an additional porous “loaded” sol gel coating approximately 3 μm in thickness was applied as in Example 1. A 0.5 μm layer of gold was applied by DC sputtering to form a top metal layer. A layer of resist was applied to the gold surface. The stainless foil was patterned and perforations formed using photolithography and a ferric chloride etch. The patterned stainless foil was protected by a resist and the gold layer patterned and was etched with perforations using a standard gold etch (iodine and sodium iodide). In this way a structure, incorporating perforated metallic layers, suitable for application as a solid oxide fuel cell was obtained. A piece of this laminated structure measuring approximately 1.5 cm×1.5 cm in area exhibited no delamination after thermal cycling as in Example 1 for 5 cycles.

### Example 6

A multilayer structure having a first metal layer consisting of 25 μm thick Grade 430 wrought stainless steel foil was prepared as outlined in Example 2. A porous “loaded” sol gel coating approximately 3 μm in thickness was applied to one side of the stainless steel foil as in Example 1. On top of this layer an additional of 5 μm thick layer of dense yttria stabilized zirconia was deposited using electron beam evaporation. A 1 μm layer of gold was applied by DC sputtering at Micralyne Inc. of Edmonton, Alberta, to form a top metal layer. A layer of resist was applied to the gold surface. The stainless foil was patterned and perforations were formed using photolithography and a ferric chloride etch. The patterned stainless foil was protected by a resist and the gold layer was patterned and etched with perforations using a standard gold etch. In this way a structure suitable for application as a solid oxide fuel cell was obtained.

### Example 7

A multilayer structure having a first metal layer consisting of 25 μm thick Grade 430 stainless steel was prepared as outlined in Example 2. A porous “loaded” sol gel coating approximately 3 μm in thickness was applied to one side of the stainless steel foil as in Example 1. On top of this layer an additional dense layer of 5 μm of dense yttria stabilized zirconia was deposited using electron beam evaporation. The stainless foil was patterned and perforations were formed using photolithography and a ferric chloride etch. A layer of thick film platinum paste was applied by screen printing to form a top metal layer. In this way a structure suitable for application as a solid oxide fuel cell was obtained.

### Example 8

A multilayer structure having a first metal layer consisting of a 25 μm thick Grade 430 wrought stainless steel foil was prepared as outlined in Example 2. A multi-phase porous “loaded” sol gel coating approximately 4 μm in thickness was applied to one side of the stainless steel foil using the technique of Example 1. However, in this example the finished “loaded” sol-gel coating consisted of nominally 2 μm sized particles of strontium doped lanthanum chromite and gadolinia doped ceria, in an approximately equal ratio by weight, encapsulated in a continuous matrix of a yttria stabilized zirconia sol-gel coating. A stabilized zirconia porous “loaded” sol gel coating approximately 3 μm in thickness was applied as in Example 1 to the top side of the multi-phase porous “loaded” sol-gel coating. To the top of this layer multiple coats of yttria containing zirconia sol were applied and heat treated to impregnate and seal the stabilized zirconia porous “loaded” sol-gel coating. On top of this “sealed” stabilized zirconia layer a second multi-phase porous “loaded” sol gel coating, similar to the first one, was applied. This structure indicated the feasibility of using the “loaded” sol-gel process in combination with sol-gel impregnation to build solid electrolyte electrochemical cells with porous electrodes incorporating multiple ionic, electronic and mixed conducting electrolyte phases, as well as a non-porous central electrolyte membrane.

All publications mentioned in this specification are indicative of the level of skill of those skilled in the art to which this invention pertains. All publications are herein incorporated by reference to the same extent as if each individual publication was specifically and individually indicated to be incorporated by reference.

The terms and expressions in this specification are, unless otherwise specifically defined herein, used as terms of description and not of limitation. There is no intention, in using such terms and expressions, of excluding equivalents of the features illustrated and described.

1. A flexible, metal-supported, solid electrolyte electrochemical cell comprising:
a) a central, non-porous, ionically- or mixed ionically- and electronically-conducting electrolyte membrane which is less than 10 μm thick and defines two major surfaces, one major surface on each side of the central electrolyte membrane;
b) a first, non-porous, metallic layer which is adhered to one of the major surfaces of the central electrolyte membrane, and having a plurality of perforations extending therethrough forming a first pattern of perforations;
c) a second, non-porous, metallic layer which is adhered to the other of the major surfaces of the central electrolyte membrane, and having a plurality of perforations extending therethrough forming a second pattern of perforations;
d) a first outer, non-porous, ionically- or mixed ionically- and electronically-conducting electrolyte layer which is:
adhered to the first metallic layer and makes intimate contact with the central electrolyte membrane through the first pattern of perforations, and
continuously ionically-conductive throughout its bulk, and electronically-conductive through its thickness from the underlying first metallic layer to any reacting gases at its outer surface;
e) a first, ionically-conductive, interface formed at a contact surface between the first outer electrolyte layer and the central electrolyte membrane;
f) a first, electronically-conductive, interface formed at a contact surface between the first metallic layer and the first outer electrolyte layer;
g) a second outer, non-porous, ionically- or mixed ionically- and electronically-conducting electrolyte layer which is:
adhered to the outer surface of the second metallic layer and makes intimate contact with the central electrolyte membrane through the second pattern of perforations, and
continuously ionically-conductive throughout its bulk, and electronically-conductive through its thickness from the underlying second metallic layer to any reacting gases at its outer surface;
h) a second, ionically-conductive interface formed at a contact surface between the second outer electrolyte layer and the central electrolyte membrane; and
i) a second, electronically-conductive interface formed at a contact surface between the second metallic layer and the second outer electrolyte layer.

2. The electrochemical cell of claim 1, wherein the first and second pattern of perforations are arranged such that the perforations are not aligned on either side of the central electrolyte membrane.

3. The electrochemical cell of claim 1, wherein the first and second pattern of perforations are arranged such that in areas, the perforations are aligned on either side of the central electrolyte, leaving the central electrolyte exposed in those aligned areas.

4. The electrochemical cell of claim 1, wherein one or both of the first and second pattern of perforations are arranged so as to vary electrochemical current density, by varying the density of the perforations from one area to another over the surface of the first and second metallic layer.

5. The electrochemical cell of claim 1, which further comprises first and second metallic interconnect elements connected with gas tight seals to the first and second metallic layers respectively for providing electrical contact from the electrochemical cell to another electrochemical cell, to form gas tight gas supply channels to provide gas to the first and second outer electrolyte layers, and to form gas tight gas exhaust channels for removing exhaust gases from the first and second outer electrolyte layers.

6. The electrochemical cell of claim 5, wherein the gas tight seals and the electrical contact between the first and second metallic interconnect elements and the first and second metallic layers respectively are provided by metallurgical bonds.

7. The electrochemical cell of claim 6, wherein the first and second metallic interconnect elements are formed with any combination of raised or depressed ridges or dimples across their surfaces, and a thickened section formed around its perimeter to provide openings for the gas supply and exhaust channels.

8. The electrochemical cell of claim 7, wherein the metallurgical bonds are formed by one or both of vacuum brazing and inert atmosphere brazing.

9. The electrochemical cell of claim 1, wherein:
the first and second metallic layers are formed from one or more of nickel, gold, silver, platinum, chromium, chromium-iron alloys, ferritic stainless steels, austenitic stainless steels, and nickel based super alloys; and
one or more of the central electrolyte membrane, and the first and second outer electrolytes are ionically- or mixed ionically- and electronically-conducting and are formed from one or more of fully stabilized zirconia, partially stabilized zirconia, doped ceria, doped bismuth oxide and perovskite oxides; and
one or more of the central electrolyte membrane, and the first and second outer electrolytes are mixed ionically and electronically-conducting and are formed from one or more of perovskite oxides, platinum, palladium and silver, and oxides of silver.

10. The electrochemical cell of claim 1, wherein:
the first and second metallic layers are formed from one or more of ferritic stainless steels and nickel based super alloys; and
one or more of the central electrolyte membrane, and the first and second outer electrolytes are ionically- or mixed ionically- and electronically-conducing and are formed from one or more of fully stabilized zirconia, partially stabilized zirconia, and doped ceria; and
one or more of the central electrolyte membrane, and the first and second outer electrolytes are mixed ionically and electronically-conducting and are formed from one or more of perovskite oxides.

11. The electrochemical cell of claim 1, wherein one or both of the first and second metallic layers are formed from wrought metal or alloy foils.

12. A flexible, metal-supported, solid electrolyte electrochemical cell comprising:
a) a central, non-porous, ionically- or mixed ionically- and electronically-conducting electrolyte membrane which is less than 10 μm thick and defines two major surfaces, one major surface on each side of the electrolyte membrane;
b) a first, porous, inner electrolyte layer which is less than 10 μm thick, is ionically- or mixed ionically- and electronically-conducting, and is adhered to one of the major surfaces of the central electrolyte membrane;
c) a first, non-porous, metallic layer which is adhered to the outer surface of the first inner electrolyte layer, and having a plurality of perforations extending therethrough forming a first pattern of perforations;
d) a first, inner, ionically-conductive interface formed at a contact surface between the central electrolyte membrane and the first inner electrolyte layer;
e) a first, inner, electronically-conductive interface formed at a contact surface between the first inner electrolyte layer and the first metallic layer;
f) a second, porous, inner electrolyte layer which is less than 10 μm thick, is ionically- or mixed ionically and electronically-conducting, and is adhered to the other of the major surfaces of the central electrolyte membrane;
g) a second, non-porous, metallic layer which is adhered to the outer surface of the second inner electrolyte layer, and having a plurality of perforations extending therethrough forming a second pattern of perforations;
h) a second, inner, ionically-conductive interface formed at a contact surface between the central electrolyte membrane and the second inner electrolyte layer;
i) a second, inner, electronically-conductive interface formed at a contact surface between the second inner electrolyte layer and the second metallic layer.

13. The electrochemical cell of claim 12 wherein, the first and second pattern of perforations are arranged such that perforations are not aligned on either side of central electrolyte layer.

14. The electrochemical cell of claim 12, wherein one or both of the first and second pattern of perforations are arranged so as to vary the electrochemical current density, by varying the density of perforations from one area to another over the surface of the first and second metallic layers.

15. The electrochemical cell of claim 12, which further comprises: first and second metallic interconnect elements connected with gas tight seals to the first and second metallic layers respectively for providing electrical contact from the electrochemical cell to another electrochemical cell, to form gas tight gas supply channels to provide gas to the first and second inner electrolyte layers, and to form gas tight gas exhaust channels for removing exhaust gases from the first and second inner electrolyte layers.

16. The electrochemical cell of claim 15, wherein the gas tight seals and the electrical contact between the first and second metallic interconnect elements and the first and second metallic layers respectively are provided by metallurgical bonds.

17. The electrochemical cell of claim 16, wherein the first and second metallic interconnect elements are formed with any combination of raised or depressed ridges or dimples across their surfaces, and a thickened section formed around its perimeter to provide openings for the gas supply and exhaust channels.

18. The electrochemical cell of claim 17, wherein the metallurgical bonds are formed by one or both of vacuum brazing and inert atmosphere brazing.

19. The electrochemical cell of claim 12, wherein one or both of the first inner electronically-conductive interface and the second inner electronically-conductive interface are modified, by a metal coating on the inner surface of one or both of the first and second metallic layers, such that in operation, metal oxide compositions are formed that enhance one or both of the electronic conductivity and the stability of the interfaces.

20. The electrochemical cell of claim 12, wherein:
the first and second metallic layers are formed from one or more of nickel, gold, silver, platinum, chromium, chromium-iron alloys, ferritic stainless steels, austenitic stainless steels, and nickel based super alloys; and
one or more of the central electrolyte membrane, and the first and second inner electrolytes are ionically- or mixed ionically- and electronically-conducting and are formed from one or more of fully stabilized zirconia, partially stabilized zirconia, doped ceria, doped bismuth oxide, perovskite oxides and pyrochlore oxides; and
one or more of the central electrolyte membrane and the first and second inner electrolytes are mixed ionically- and electronically-conducting and are formed from one or more of perovskite oxides, platinum, palladium and silver, and oxides of silver.

21. The electrochemical cell of claim 12, wherein:
the first and second metallic layers are formed from one or more of ferritic stainless steels, and nickel based super alloys; and
one or more of the central electrolyte membrane, and the first and second inner electrolyte layers are ionically- or mixed ionically- and electronically-conducting and are formed from one or more of fully stabilized zirconia, partially stabilized zirconia, and doped ceria; and
one or more of the central electrolyte membrane and the first and second inner electrolyte layers are mixed ionically- and electronically-conducting and are formed from of perovskite oxides.

22. The electrochemical cell of claim 12, wherein the one or both of the first and second metallic layers are formed from metal or metal alloy foils.

23. The electrochemical cell of claim 12, wherein one or both of the first and second inner electrolyte layer is in the form of a coating comprising particles of ionically-conducting, mixed ionically- and electronically-conducting, or electronically-conducting materials, encapsulated in, and bonded together by, a sol-gel of an ionically-conducting or mixed ionically- and electronically-conducting ceramic oxide material.

24. The electrochemical cell of claim 23, wherein the central electrolyte membrane is in the form of a coating comprising particles of ionically-conducting, mixed ionically- and electronically-conducting, or electronically-conducting materials, encapsulated in, and bonded together by, a sol-gel of an ionically-conducting or mixed ionically- and electronically-conducting ceramic oxide material, and further impregnated with one or more sol-gels to seal off interconnected porosity.

25. The electrochemical cell of claim 12, which further comprises one or both of:
a first, outer, electrolyte layer formed of one or more metal oxide ceramics, and adhered to the outer surface of the first metallic layer; and
a second, outer, electrolyte layer formed of one or more metal oxide ceramics, and adhered to the outer surface of the second metallic layer.

26. The electrochemical cell of claim 25, wherein one or both of the first and second outer electrolyte layers include hydrocarbon fuel reforming or selective oxidation catalysts, selected from metals and oxides of metals from Groups II, V, VI, VII, VIII, IX, X, XI, XV and the F Block lanthanides of the Periodic Table of elements.

27. The electrochemical cell of claim 23, for use as a solid oxide fuel cell, wherein:
the first metallic layer is formed from a wrought ferritic stainless steel foil;
the central electrolyte membrane is formed of stabilized zirconia;
the second metallic layer is formed as a coating from ferritic stainless steel;
the first and second inner electrolyte layers are mixed ionically- and electronically-conducting and are formed of one or more of stabilized zirconia, doped ceria and lanthanum strontium chromite.

28. The electrochemical cell of claim 23, for use as a solid oxide fuel cell, wherein:
the first metallic layer and the second metallic layer are formed from a wrought ferritic stainless steel foil;
the central electrolyte membrane is formed of stabilized zirconia;
the first and second inner electrolyte layers are mixed ionically- and electronically-conducting and are formed of one or more of stabilized zirconia, doped ceria and lanthanum strontium chromite.

29. A metallurgically bonded, multi-cell, solid electrolyte electrochemical reactor assembly formed from a plurality of metal-supported solid electrolyte electrochemical cells, each of which has an anode and cathode electrode, and which are connected in electrical series, comprising:
a) a plurality of flexible, metal-supported, solid electrolyte electrochemical cells as defined in claim 1, wherein each of the first metallic layer and the second metallic layer function individually as a component of, and an electronic current collector or distributor for, either the anode or cathode electrode of the cell, such that if the first metallic layer forms part of the cell's anode electrode then the second metallic layer forms part of the cell's cathode electrode and vice versa;
b) metallic interconnect elements between which the electrochemical cells are interleaved, each such metallic interconnect element being formed with any combination of raised or depressed ridges or dimples across its surface, and a thickened section formed around its perimeter with channels formed therein around its perimeter, such that when metallurgically bonded to the first or second metallic layer of the adjoining electrochemical cells gas-tight seals and electrical contacts are formed between the first or second metallic layer of the adjoining cells and the metallic interconnect element, providing gas flow channels across the outer surfaces of the adjoining cells as well as electrical interconnection between the adjoining cells;
c) openings located around the perimeter of the electrochemical cells and aligned with matching openings in the metallic interconnect elements, such that when the cells and the interconnect elements are metallurgically bonded together, these openings align to provide gas supply and exhaust manifolds, running transversely to the plane of the cells and the metallic interconnect elements, for gas flow communication with any gas flow channels at the outer surfaces of the cells;
d) a top end assembly which is metallurgically bonded to the topmost metallic interconnect element and which provides gas flow communication between the gas supply and exhaust manifolds and any gas supply and exhaust piping that is external to the reactor assembly;
e) a bottom end assembly which is metallurgically bonded to the bottommost metallic interconnect element and which seals off the ends of the gas supply and exhaust manifolds and directs gas flows to and from the bottommost electrochemical cell;
f) the reactor assembly and any of its structural supports being electrically isolated, and the reactor assembly and any external gas supply and exhaust piping being electrically isolated; and
g) two external electrical terminations, one connected to the top end assembly and the other connected to the bottom end assembly.

30. The reactor assembly of claim 29, wherein a plan projection of the cells and the metallic interconnect elements is rectangular in shape, and wherein the gas supply and exhaust manifolds are arranged along both of the long sides of the rectangle.

31. The reactor assembly of claim 30, wherein the metallurgical bonds are formed one or both of vacuum brazing and inert atmosphere brazing.

32. The reactor assembly of claim 31, wherein the metal-supported electrochemical cells are as set forth in claim 1.

33. The reactor assembly of claim 31, wherein the metal-supported electrochemical cells are as set forth in claim 12.

34. The reactor assembly of claim 31, wherein the metal-supported electrochemical cells are as set forth in claim 22.

35. The reactor assembly of claim 31, wherein the metal-supported electrochemical cells are as set forth in claim 23.

36. The reactor assembly of claim 31, wherein the metal-supported electrochemical cells are as set forth in claim 27.

37. A process of forming a flexible metal-supported solid electrolyte electrochemical cell, comprising:
a) providing a wrought metal or alloy foil to form a first metallic layer and to function as a supporting substrate;
b) applying a non-porous, ionically-conducting or mixed ionically- and electronically-conducting electrolyte coating, which is less than 10 μm thick, to one surface of the first metallic layer to form a central electrolyte membrane;
c) applying a non-porous metallic coating on top of the central electrolyte membrane to form a second metallic layer;
d) forming a first pattern of perforations in the first metallic layer;
e) forming a second pattern of perforations in the second metallic layer;
f) applying a first, non-porous, mixed ionically- and electronically-conducting electrolyte coating, which is less than 4 μm thick, over the outer surface of the first metallic layer to provide a first outer electrolyte layer; and
g) applying a second, non-porous, mixed ionically- and electronically-conducting electrolyte coating, which is less than 4 μm thick, over the outer surface of the second metallic layer to provide a second outer electrolyte layer.

38. The process of claim 37, wherein the perforations in each of the first and second metallic layers are formed by etching with a photo-chemical machining process while protecting the other of the first and second metallic layers from the etchant.

39. The process of claim 37, wherein:
the second metallic layer is formed by one or more of DC sputtering, e-beam evaporation, and electro-plating; and
the central electrolyte membrane and the first and second outer electrolyte layers are provided by one or more of reactive DC sputtering, AC sputtering e-beam evaporation, polarized electrochemical deposition, multi-layer sol-gel coating, and particle-filled sol-gel coatings further impregnated with sol-gel coatings.

40. A process of forming a flexible metal-supported solid electrolyte electrochemical cell, comprising:
a) providing a wrought metal or alloy foil to form a first metallic layer and to function as a supporting substrate;
b) applying a porous, ionically- or mixed ionically- and electronically-conducting electrolyte coating, which is less than 10 μm thick, to one surface of the first metallic layer to form a first, porous, inner electrolyte layer;
c) applying a non-porous, ionically-conducting or mixed ionically- and electronically-conducting electrolyte coating, which is less than 10 μm thick, to the surface of the first inner electrolyte layer to form a central electrolyte membrane;
d) applying a porous, ionically-conducting or mixed ionically- and electronically-conducting electrolyte coating, which is less than 10 μm thick, to the surface of the central electrolyte membrane to form a second, porous, inner electrolyte layer;
e) applying a non-porous, metallic coating on top of the second inner electrolyte layer to form a second metallic layer;
f) forming a first pattern of perforations in the first metallic layer; and
g) forming a second pattern of perforations in the second metallic layer.

41. The process of claim 40, wherein the perforations in each of the first and second metallic layers are formed by etching with a photo-chemical machining process while protecting the other of the first and second metallic layers from the etchant.

42. The process of claim 40, which further comprises one or both of the steps of:
h) applying a ceramic electrolyte coating, which is less than 4 μm thick, to the outer surface of the first metallic layer to provide a first, outer, electrolyte layer; and
i) applying a ceramic electrolyte coating, which is less than 4 μm thick, to the outer surface of the second metallic layer to provide a second, outer, electrolyte layer.

43. The process of claim 43 wherein:
The second metallic layer is formed by one or more of DC sputtering, e-beam evaporation, and electro plating;
the first and second inner electrolyte layers are provided by applying a single layer or multi layer composite coating, comprising particles comprising particles of ionically-conducting, mixed ionically- and electronically-conducting, or electronically-conducting materials, encapsulated in, and bonded together by, a sol-gel of an ionically-conducting or mixed ionically- and electronically-conducting ceramic oxide material; and
the central electrolyte membrane is provided by one or more of reactive DC sputtering, AC sputtering e-beam evaporation, polarized electrochemical deposition, multi-layer sol-gel coating, and particle-filled sol-gel coatings further impregnated with sol-gel.

44. A process of forming a flexible metal-supported solid electrolyte electrochemical cell, comprising:
a) providing a first wrought metal or alloy foil to form a first metallic layer and to function as a supporting substrate;
b) providing a second wrought metal or alloy foil substrate to form a second metallic layer;
c) forming a second pattern of perforations in the second metallic layer;
d) applying a single layer or multi layer composite porous electrolyte coating, which is less than 10 μm thick, and which comprises particles of ionically-conducting, mixed ionically- and electronically-conducting, or electronically-conducting materials, encapsulated in, and bonded together by, a sol-gel of an ionically-conducting or mixed ionically- and electronically-conducting ceramic oxide, to one surface of the first metallic layer to form a first, porous, inner electrolyte layer;
e) applying a non-porous, ionically-conducting or mixed ionically- and electronically-conducting electrolyte coating, which is less than 10 μm thick, to the surface of the first inner electrolyte layer to form a central electrolyte membrane;
f) applying a porous electrolyte coating, which is less than 10 μm thick, and which comprises particles of ionically-conducting, mixed ionically- and electronically-conducting, or electronically-conducting materials, encapsulated in, and bonded together by, a sol-gel of an ionically-conducting or mixed ionically- and electronically-conducting ceramic oxide material, to the surface of the central electrolyte membrane and to one surface of the second metallic layer, bonding the porous electrolyte coating together to simultaneously form a second, porous, inner electrolyte layer and laminate the second metallic layer thereto;
g) forming a first pattern of perforations in the first metallic layer.

45. The process of claim 44 wherein the perforations in each of the first and second metallic layers are formed by etching with a photo-chemical machining process, and wherein when the first pattern of perforations are formed, the second metallic layer is protected from the etchant.

46. The process of claim 44, which further comprises one or both of the steps of:
a) applying a ceramic electrolyte coating, which is less than 4 μm thick, to the outer surface of the first metallic layer to provide a first, outer, electrolyte layer; and
b) applying a ceramic electrolyte coating, which is less than 4 μm thick, to the outer surface of the second metallic layer to provide a second, outer electrolyte layer.

47. The process of claim 46, wherein the central electrolyte membrane is provided by one or more of reactive DC sputtering, AC sputtering e-beam evaporation, polarized electrochemical deposition, multi-layer sol-gel coating, and particle-filled sol-gel coatings further impregnated with sol-gel coatings.

48. The electrochemical cell of claim 2, wherein one or both of the first and second pattern of perforations are arranged so as to vary electrochemical current density, by varying the density of the perforations from one area to another over the surface of the first and second metallic layer.

49. The electrochemical cell of claim 3, wherein one or both of the first and second pattern of perforations are arranged so as to vary electrochemical current density, by varying the density of the perforations from one area to another over the surface of the first and second metallic layer.

50. The electrochemical cell of claim 7, wherein one or both of the first and second metallic layers are formed from wrought metal or alloy foils.

51. The electrochemical cell of claim 8, wherein one or both of the first and second metallic layers are formed from wrought metal or alloy foils.

52. The electrochemical cell of claim 13, wherein one or both of the first and second pattern of perforations are arranged so as to vary the electrochemical current density, by varying the density of perforations from one area to another over the surface of the first and second metallic layers.

53. The electrochemical cell of claim 20, wherein the one or both of the first and second metallic layers are formed from metal or metal alloy foils.

54. The electrochemical cell of claim 21, wherein the one or both of the first and second metallic layers are formed from metal or metal alloy foils.

55. The electrochemical cell of claim 24, for use as a solid oxide fuel cell, wherein:
the first metallic layer is formed from a wrought ferritic stainless steel foil;
the central electrolyte membrane is formed of stabilized zirconia;
the second metallic layer is formed as a coating from ferritic stainless steel;
the first and second inner electrolyte layers are mixed ionically- and electronically-conducting and are formed of one or more of stabilized zirconia, doped ceria and lanthanum strontium chromite.

56. The electrochemical cell of claim 24, for use as a solid oxide fuel cell, wherein:
the first metallic layer and the second metallic layer are formed from a wrought ferritic stainless steel foil;
the central electrolyte membrane is formed of stabilized zirconia;
the first and second inner electrolyte layers are mixed ionically- and electronically-conducting and are formed of one or more of stabilized zirconia, doped ceria and lanthanum strontium chromite.

57. A metallurgically bonded, multi-cell, solid electrolyte electrochemical reactor assembly formed from a plurality of metal-supported solid electrolyte electrochemical cells, each of which has an anode and cathode electrode, and which are connected in electrical series, comprising:
a) a plurality of flexible, metal-supported, solid electrolyte electrochemical cells as defined in claim 12, wherein each of the first metallic layer and the second metallic layer function individually as a component of, and an electronic current collector or distributor for, either the anode or cathode electrode of the cell, such that if the first metallic layer forms part of the cell's anode electrode then the second metallic layer forms part of the cell's cathode electrode and vice versa;
b) metallic interconnect elements between which the electrochemical cells are interleaved, each such metallic interconnect element being formed with any combination of raised or depressed ridges or dimples across its surface, and a thickened section formed around its perimeter with channels formed therein around its perimeter, such that when metallurgically bonded to the first or second metallic layer of the adjoining electrochemical cells gas-tight seals and electrical contacts are formed between the first or second metallic layer of the adjoining cells and the metallic interconnect element, providing gas flow channels across the outer surfaces of the adjoining cells as well as electrical interconnection between the adjoining cells;
c) openings located around the perimeter of the electrochemical cells and aligned with matching openings in the metallic interconnect elements, such that when the cells and the interconnect elements are metallurgically bonded together, these openings align to provide gas supply and exhaust manifolds, running transversely to the plane of the cells and the metallic interconnect elements, for gas flow communication with any gas flow channels at the outer surfaces of the cells;
d) a top end assembly which is metallurgically bonded to the topmost metallic interconnect element and which provides gas flow communication between the gas supply and exhaust manifolds and any gas supply and exhaust piping that is external to the reactor assembly;
e) a bottom end assembly which is metallurgically bonded to the bottommost metallic interconnect element and which seals off the ends of the gas supply and exhaust manifolds and directs gas flows to and from the bottommost electrochemical cell;
f) the reactor assembly and any of its structural supports being electrically isolated, and the reactor assembly and any external gas supply and exhaust piping being electrically isolated; and
g) two external electrical terminations, one connected to the top end assembly and the other connected to the bottom end assembly.

58. A metallurgically bonded, multi-cell, solid electrolyte electrochemical reactor assembly formed from a plurality of metal-supported solid electrolyte electrochemical cells, each of which has an anode and cathode electrode, and which are connected in electrical series, comprising:
a) a plurality of flexible, metal-supported, solid electrolyte electrochemical cells as defined in claim 22, wherein each of the first metallic layer and the second metallic layer function individually as a component of, and an electronic current collector or distributor for, either the anode or cathode electrode of the cell, such that if the first metallic layer forms part of the cell's anode electrode then the second metallic layer forms part of the cell's cathode electrode and vice versa;
b) metallic interconnect elements between which the electrochemical cells are interleaved, each such metallic interconnect element being formed with any combination of raised or depressed ridges or dimples across its surface, and a thickened section formed around its perimeter with channels formed therein around its perimeter, such that when metallurgically bonded to the first or second metallic layer of the adjoining electrochemical cells gas-tight seals and electrical contacts are formed between the first or second metallic layer of the adjoining cells and the metallic interconnect element, providing gas flow channels across the outer surfaces of the adjoining cells as well as electrical interconnection between the adjoining cells;
c) openings located around the perimeter of the electrochemical cells and aligned with matching openings in the metallic interconnect elements, such that when the cells and the interconnect elements are metallurgically bonded together, these openings align to provide gas supply and exhaust manifolds, running transversely to the plane of the cells and the metallic interconnect elements, for gas flow communication with any gas flow channels at the outer surfaces of the cells;
d) a top end assembly which is metallurgically bonded to the topmost metallic interconnect element and which provides gas flow communication between the gas supply and exhaust manifolds and any gas supply and exhaust piping that is external to the reactor assembly;
e) a bottom end assembly which is metallurgically bonded to the bottommost metallic interconnect element and which seals off the ends of the gas supply and exhaust manifolds and directs gas flows to and from the bottommost electrochemical cell;
f) the reactor assembly and any of its structural supports being electrically isolated, and the reactor assembly and any external gas supply and exhaust piping being electrically isolated; and
g) two external electrical terminations, one connected to the top end assembly and the other connected to the bottom end assembly.

59. A metallurgically bonded, multi-cell, solid electrolyte electrochemical reactor assembly formed from a plurality of metal-supported solid electrolyte electrochemical cells, each of which has an anode and cathode electrode, and which are connected in electrical series, comprising:
a) a plurality of flexible, metal-supported, solid electrolyte electrochemical cells as defined in claim 23, wherein each of the first metallic layer and the second metallic layer function individually as a component of, and an electronic current collector or distributor for, either the anode or cathode electrode of the cell, such that if the first metallic layer forms part of the cell's anode electrode then the second metallic layer forms part of the cell's cathode electrode and vice versa;
b) metallic interconnect elements between which the electrochemical cells are interleaved, each such metallic interconnect element being formed with any combination of raised or depressed ridges or dimples across its surface, and a thickened section formed around its perimeter with channels formed therein around its perimeter, such that when metallurgically bonded to the first or second metallic layer of the adjoining electrochemical cells gas-tight seals and electrical contacts are formed between the first or second metallic layer of the adjoining cells and the metallic interconnect element, providing gas flow channels across the outer surfaces of the adjoining cells as well as electrical interconnection between the adjoining cells;
c) openings located around the perimeter of the electrochemical cells and aligned with matching openings in the metallic interconnect elements, such that when the cells and the interconnect elements are metallurgically bonded together, these openings align to provide gas supply and exhaust manifolds, running transversely to the plane of the cells and the metallic interconnect elements, for gas flow communication with any gas flow channels at the outer surfaces of the cells;
d) a top end assembly which is metallurgically bonded to the topmost metallic interconnect element and which provides gas flow communication between the gas supply and exhaust manifolds and any gas supply and exhaust piping that is external to the reactor assembly;
e) a bottom end assembly which is metallurgically bonded to the bottommost metallic interconnect element and which seals off the ends of the gas supply and exhaust manifolds and directs gas flows to and from the bottommost electrochemical cell;
f) the reactor assembly and any of its structural supports being electrically isolated, and the reactor assembly and any external gas supply and exhaust piping being electrically isolated; and
g) two external electrical terminations, one connected to the top end assembly and the other connected to the bottom end assembly.

60. A metallurgically bonded, multi-cell, solid electrolyte electrochemical reactor assembly formed from a plurality of metal-supported solid electrolyte electrochemical cells, each of which has an anode and cathode electrode, and which are connected in electrical series, comprising:
a) a plurality of flexible, metal-supported, solid electrolyte electrochemical cells as defined in claim 27, wherein each of the first metallic layer and the second metallic layer function individually as a component of, and an electronic current collector or distributor for, either the anode or cathode electrode of the cell, such that if the first metallic layer forms part of the cell's anode electrode then the second metallic layer forms part of the cell's cathode electrode and vice versa;
b) metallic interconnect elements between which the electrochemical cells are interleaved, each such metallic interconnect element being formed with any combination of raised or depressed ridges or dimples across its surface, and a thickened section formed around its perimeter with channels formed therein around its perimeter, such that when metallurgically bonded to the first or second metallic layer of the adjoining electrochemical cells gas-tight seals and electrical contacts are formed between the first or second metallic layer of the adjoining cells and the metallic interconnect element, providing gas flow channels across the outer surfaces of the adjoining cells as well as electrical interconnection between the adjoining cells;
c) openings located around the perimeter of the electrochemical cells and aligned with matching openings in the metallic interconnect elements, such that when the cells and the interconnect elements are metallurgically bonded together, these openings align to provide gas supply and exhaust manifolds, running transversely to the plane of the cells and the metallic interconnect elements, for gas flow communication with any gas flow channels at the outer surfaces of the cells;
d) a top end assembly which is metallurgically bonded to the topmost metallic interconnect element and which provides gas flow communication between the gas supply and exhaust manifolds and any gas supply and exhaust piping that is external to the reactor assembly;
e) a bottom end assembly which is metallurgically bonded to the bottommost metallic interconnect element and which seals off the ends of the gas supply and exhaust manifolds and directs gas flows to and from the bottommost electrochemical cell;
f) the reactor assembly and any of its structural supports being electrically isolated, and the reactor assembly and any external gas supply and exhaust piping being electrically isolated; and
g) two external electrical terminations, one connected to the top end assembly and the other connected to the bottom end assembly.

61. A metallurgically bonded, multi-cell, solid electrolyte electrochemical reactor assembly formed from a plurality of metal-supported solid electrolyte electrochemical cells, each of which has an anode and cathode electrode, and which are connected in electrical series, comprising:
a) a plurality of flexible, metal-supported, solid electrolyte electrochemical cells as defined in claim 53, wherein each of the first metallic layer and the second metallic layer function individually as a component of, and an electronic current collector or distributor for, either the anode or cathode electrode of the cell, such that if the first metallic layer forms part of the cell's anode electrode then the second metallic layer forms part of the cell's cathode electrode and vice versa;
b) metallic interconnect elements between which the electrochemical cells are interleaved, each such metallic interconnect element being formed with any combination of raised or depressed ridges or dimples across its surface, and a thickened section formed around its perimeter with channels formed therein around its perimeter, such that when metallurgically bonded to the first or second metallic layer of the adjoining electrochemical cells gas-tight seals and electrical contacts are formed between the first or second metallic layer of the adjoining cells and the metallic interconnect element, providing gas flow channels across the outer surfaces of the adjoining cells as well as electrical interconnection between the adjoining cells;
c) openings located around the perimeter of the electrochemical cells and aligned with matching openings in the metallic interconnect elements, such that when the cells and the interconnect elements are metallurgically bonded together, these openings align to provide gas supply and exhaust manifolds, running transversely to the plane of the cells and the metallic interconnect elements, for gas flow communication with any gas flow channels at the outer surfaces of the cells;
d) a top end assembly which is metallurgically bonded to the topmost metallic interconnect element and which provides gas flow communication between the gas supply and exhaust manifolds and any gas supply and exhaust piping that is external to the reactor assembly;
e) a bottom end assembly which is metallurgically bonded to the bottommost metallic interconnect element and which seals off the ends of the gas supply and exhaust manifolds and directs gas flows to and from the bottommost electrochemical cell;
f) the reactor assembly and any of its structural supports being electrically isolated, and the reactor assembly and any external gas supply and exhaust piping being electrically isolated; and
g) two external electrical terminations, one connected to the top end assembly and the other connected to the bottom end assembly.

62. A metallurgically bonded, multi-cell, solid electrolyte electrochemical reactor assembly formed from a plurality of metal-supported solid electrolyte electrochemical cells, each of which has an anode and cathode electrode, and which are connected in electrical series, comprising:
a) a plurality of flexible, metal-supported, solid electrolyte electrochemical cells as defined in claims 54, wherein each of the first metallic layer and the second metallic layer function individually as a component of, and an electronic current collector or distributor for, either the anode or cathode electrode of the cell, such that if the first metallic layer forms part of the cell's anode electrode then the second metallic layer forms part of the cell's cathode electrode and vice versa;
b) metallic interconnect elements between which the electrochemical cells are interleaved, each such metallic interconnect element being formed with any combination of raised or depressed ridges or dimples across its surface, and a thickened section formed around its perimeter with channels formed therein around its perimeter, such that when metallurgically bonded to the first or second metallic layer of the adjoining electrochemical cells gas-tight seals and electrical contacts are formed between the first or second metallic layer of the adjoining cells and the metallic interconnect element, providing gas flow channels across the outer surfaces of the adjoining cells as well as electrical interconnection between the adjoining cells;
c) openings located around the perimeter of the electrochemical cells and aligned with matching openings in the metallic interconnect elements, such that when the cells and the interconnect elements are metallurgically bonded together, these openings align to provide gas supply and exhaust manifolds, running transversely to the plane of the cells and the metallic interconnect elements, for gas flow communication with any gas flow channels at the outer surfaces of the cells;
d) a top end assembly which is metallurgically bonded to the topmost metallic interconnect element and which provides gas flow communication between the gas supply and exhaust manifolds and any gas supply and exhaust piping that is external to the reactor assembly;
e) a bottom end assembly which is metallurgically bonded to the bottommost metallic interconnect element and which seals off the ends of the gas supply and exhaust manifolds and directs gas flows to and from the bottommost electrochemical cell;
f) the reactor assembly and any of its structural supports being electrically isolated, and the reactor assembly and any external gas supply and exhaust piping being electrically isolated; and
g) two external electrical terminations, one connected to the top end assembly and the other connected to the bottom end assembly.

63. A metallurgically bonded, multi-cell, solid electrolyte electrochemical reactor assembly formed from a plurality of metal-supported solid electrolyte electrochemical cells, each of which has an anode and cathode electrode, and which are connected in electrical series, comprising:
a) a plurality of flexible, metal-supported, solid electrolyte electrochemical cells as defined in claim 55, wherein each of the first metallic layer and the second metallic layer function individually as a component of, and an electronic current collector or distributor for, either the anode or cathode electrode of the cell, such that if the first metallic layer forms part of the cell's anode electrode then the second metallic layer forms part of the cell's cathode electrode and vice versa;
b) metallic interconnect elements between which the electrochemical cells are interleaved, each such metallic interconnect element being formed with any combination of raised or depressed ridges or dimples across its surface, and a thickened section formed around its perimeter with channels formed therein around its perimeter, such that when metallurgically bonded to the first or second metallic layer of the adjoining electrochemical cells gas-tight seals and electrical contacts are formed between the first or second metallic layer of the adjoining cells and the metallic interconnect element, providing gas flow channels across the outer surfaces of the adjoining cells as well as electrical interconnection between the adjoining cells;
c) openings located around the perimeter of the electrochemical cells and aligned with matching openings in the metallic interconnect elements, such that when the cells and the interconnect elements are metallurgically bonded together, these openings align to provide gas supply and exhaust manifolds, running transversely to the plane of the cells and the metallic interconnect elements, for gas flow communication with any gas flow channels at the outer surfaces of the cells;
d) a top end assembly which is metallurgically bonded to the topmost metallic interconnect element and which provides gas flow communication between the gas supply and exhaust manifolds and any gas supply and exhaust piping that is external to the reactor assembly;
e) a bottom end assembly which is metallurgically bonded to the bottommost metallic interconnect element and which seals off the ends of the gas supply and exhaust manifolds and directs gas flows to and from the bottommost electrochemical cell;
f) the reactor assembly and any of its structural supports being electrically isolated, and the reactor assembly and any external gas supply and exhaust piping being electrically isolated; and
g) two external electrical terminations, one connected to the top end assembly and the other connected to the bottom end assembly.

64. The reactor assembly of claim 57, wherein a plan projection of the cells and the metallic interconnect elements is rectangular in shape, and wherein the gas supply and exhaust manifolds are arranged along both of the long sides of the rectangle.

65. The reactor assembly of claim 58, wherein a plan projection of the cells and the metallic interconnect elements is rectangular in shape, and wherein the gas supply and exhaust manifolds are arranged along both of the long sides of the rectangle.

66. The reactor assembly of claim 59, wherein a plan projection of the cells and the metallic interconnect elements is rectangular in shape, and wherein the gas supply and exhaust manifolds are arranged along both of the long sides of the rectangle.

67. The reactor assembly of claim 60, wherein a plan projection of the cells and the metallic interconnect elements is rectangular in shape, and wherein the gas supply and exhaust manifolds are arranged along both of the long sides of the rectangle.

68. The reactor assembly of claim 62, wherein a plan projection of the cells and the metallic interconnect elements is rectangular in shape, and wherein the gas supply and exhaust manifolds are arranged along both of the long sides of the rectangle.

69. The reactor assembly of claim 63, wherein a plan projection of the cells and the metallic interconnect elements is rectangular in shape, and wherein the gas supply and exhaust manifolds are arranged along both of the long sides of the rectangle.

70. The reactor assembly of claim 64, wherein the metallurgical bonds are formed one or both of vacuum brazing and inert atmosphere brazing.

71. The reactor assembly of claim 65, wherein the metallurgical bonds are formed one or both of vacuum brazing and inert atmosphere brazing.

72. The reactor assembly of claim 66, wherein the metallurgical bonds are formed one or both of vacuum brazing and inert atmosphere brazing.

73. The reactor assembly of claim 67, wherein the metallurgical bonds are formed one or both of vacuum brazing and inert atmosphere brazing.

74. The reactor assembly of claim 68, wherein the metallurgical bonds are formed one or both of vacuum brazing and inert atmosphere brazing.

75. The reactor assembly of claim 69, wherein the metallurgical bonds are formed one or both of vacuum brazing and inert atmosphere brazing.

76. The reactor assembly of claim 70, wherein the metal-supported electrochemical cells are as set forth in claim 1.

77. The reactor assembly of claim 71, wherein the metal-supported electrochemical cells are as set forth in claim 1.

78. The reactor assembly of claim 72, wherein the metal-supported electrochemical cells are as set forth in claim 1.

79. The reactor assembly of claim 73, wherein the metal-supported electrochemical cells are as set forth in claim 1.

80. The reactor assembly of claim 74, wherein the metal-supported electrochemical cells are as set forth in claim 1.

81. The reactor assembly of claim 75, wherein the metal-supported electrochemical cells are as set forth in claim 1.

82. The reactor assembly of claim 70, wherein the metal-supported electrochemical cells are as set forth in claim 12.

83. The reactor assembly of claim 71, wherein the metal-supported electrochemical cells are as set forth in claim 12.

84. The reactor assembly of claim 72, wherein the metal-supported electrochemical cells are as set forth in claim 12.

85. The reactor assembly of claim 73, wherein the metal-supported electrochemical cells are as set forth in claim 12.

86. The reactor assembly of claim 74, wherein the metal-supported electrochemical cells are as set forth in claim 12.

87. The reactor assembly of claim 75, wherein the metal-supported electrochemical cells are as set forth in claim 12.

88. The reactor assembly of claim 70, wherein the metal-supported electrochemical cells are as set forth in claim 22.

89. The reactor assembly of claim 71, wherein the metal-supported electrochemical cells are as set forth in claim 22.

90. The reactor assembly of claim 72, wherein the metal-supported electrochemical cells are as set forth in claim 22.

91. The reactor assembly of claim 73, wherein the metal-supported electrochemical cells are as set forth in claim 22.

92. The reactor assembly of claim 74, wherein the metal-supported electrochemical cells are as set forth in claim 22.

93. The reactor assembly of claim 75, wherein the metal-supported electrochemical cells are as set forth in claim 22.

94. The reactor assembly of claim 70, wherein the metal-supported electrochemical cells are as set forth in claim 53.

95. The reactor assembly of claim 71, wherein the metal-supported electrochemical cells are as set forth in claim 53.

96. The reactor assembly of claim 72, wherein the metal-supported electrochemical cells are as set forth in claim 53.

97. The reactor assembly of claim 73, wherein the metal-supported electrochemical cells are as set forth in claim 53.

98. The reactor assembly of claim 74, wherein the metal-supported electrochemical cells are as set forth in claim 53.

99. The reactor assembly of claim 75, wherein the metal-supported electrochemical cells are as set forth in claim 53.

100. The reactor assembly of claim 70, wherein the metal-supported electrochemical cells are as set forth in claim 54.

101. The reactor assembly of claim 71, wherein the metal-supported electrochemical cells are as set forth in claim 54.

102. The reactor assembly of claim 72, wherein the metal-supported electrochemical cells are as set forth in claim 54.

103. The reactor assembly of claim 73, wherein the metal-supported electrochemical cells are as set forth in claim 54.

104. The reactor assembly of claim 74, wherein the metal-supported electrochemical cells are as set forth in claim 54.

105. The reactor assembly of claim 75, wherein the metal-supported electrochemical cells are as set forth in claim 54.

106. The reactor assembly of claim 70, wherein the metal-supported electrochemical cells are as set forth in claim 23.

107. The reactor assembly of claim 71, wherein the metal-supported electrochemical cells are as set forth in claim 23.

108. The reactor assembly of claim 72, wherein the metal-supported electrochemical cells are as set forth in claim 23.

109. The reactor assembly of claim 73, wherein the metal-supported electrochemical cells are as set forth in claim 23.

110. The reactor assembly of claim 74, wherein the metal-supported electrochemical cells are as set forth in claim 23.

111. The reactor assembly of claim 75, wherein the metal-supported electrochemical cells are as set forth in claim 23.

112. The reactor assembly of claim 70, wherein the metal-supported electrochemical cells are as set forth in claim 27.

113. The reactor assembly of claim 71, wherein the metal-supported electrochemical cells are as set forth in claim 27.

114. The reactor assembly of claim 72, wherein the metal-supported electrochemical cells are as set forth in claim 27.

115. The reactor assembly of claim 73, wherein the metal-supported electrochemical cells are as set forth in claim 27.

116. The reactor assembly of claim 74, wherein the metal-supported electrochemical cells are as set forth in claim 27.

117. The reactor assembly of claim 75, wherein the metal-supported electrochemical cells are as set forth in claim 27.

118. The reactor assembly of claim 70, wherein the metal-supported electrochemical cells are as set forth in claim 55.

119. The reactor assembly of claim 71, wherein the metal-supported electrochemical cells are as set forth in claim 55.

120. The reactor assembly of claim 72, wherein the metal-supported electrochemical cells are as set forth in claim 55.

121. The reactor assembly of claim 73, wherein the metal-supported electrochemical cells are as set forth in claim 55.

122. The reactor assembly of claim 74, wherein the metal-supported electrochemical cells are as set forth in claim 55.

123. The reactor assembly of claim 75, wherein the metal-supported electrochemical cells are as set forth in claim 55.

124. The process of claim 38, wherein:
the second metallic layer is formed by one or more of DC sputtering, e-beam evaporation, and electro-plating; and
the central electrolyte membrane and the first and second outer electrolyte layers are provided by one or more of reactive DC sputtering, AC sputtering e-beam evaporation, polarized electrochemical deposition, multi-layer sol-gel coating, and particle-filled sol-gel coatings further impregnated with sol-gel coatings.
